(19) United States
(12) Patent Application Publication
(10) Pub. No.: US 2014/0059486 A1
(43) Pub. Date: Feb. 27, 2014

(54) ULTRASONIC DIAGNOSTIC APPARATUS, DIAGNOSTIC IMAGING APPARATUS, IMAGE PROCESSING APPARATUS, AND PROGRAM STORED IN NON-TRANSITORY COMPUTER-READABLE RECORDING MEDIUM EXECUTED BY COMPUTER

(71) Applicants: TOSHIBA MEDICAL SYSTEMS CORPORATION, Otawara-Shi (JP); KABUSHIKI KAISHA TOSHIBA, Tokyo (JP)

(72) Inventors: Takuya Sasaki, Nasu-gun (JP); Chihiro Shibata, Nasushiobara-shi (JP); Kuramitsu Nishihara, Otawara-shi (JP); Atsushi Sumi, Otawara-shi (JP)

(73) Assignees: TOSHIBA MEDICAL SYSTEMS CORPORATION, Otawara-Shi (JP); KABUSHIKI KAISHA TOSHIBA, Tokyo (JP)

(21) Appl. No.: 14/069,929

(22) Filed: Nov. 1, 2013

Related U.S. Application Data
(63) Continuation of application No. PCT/JP2013/066666, filed on Jun. 18, 2013.

(30) Foreign Application Priority Data
Jul. 2, 2012 (JP) 2012-148838

(51) Int. Cl. G06F 3/0482; G06F 3/0488; G06F 19/00; G06F 3/0484

(52) U.S. Cl. CPC G06F 3/0482; G06F 3/04842; G06F 3/0488; G06F 19/32
USPC 715/810

(57) ABSTRACT

An ultrasonic diagnostic apparatus equipped with a display unit configured to display an ultrasonic image, has a controller. The controller executes a setting for a position of an area of interest in the displayed ultrasonic image and a displaying of a mode selection menu on the display unit, simultaneously, in response to a single action while the ultrasonic image is displayed on the display unit.

### CROSS-REFERENCE TO RELATED APPLICATION

This application is a Continuation Application of No. PCT/JP2013/066666, filed on Jun. 18, 2013, and the PCT application is based upon and claims the benefit of priority from Japanese Patent Application No. 2012-148838, filed on Jul. 2, 2012, the entire contents of which are incorporated herein by reference.

### FIELD

The present embodiment relates to an ultrasonic diagnostic apparatus, a diagnostic imaging apparatus, an image processing apparatus, and a program stored in a non-transitory computer-readable recording medium executed by a computer, which displays images.

### BACKGROUND

An ultrasonic diagnostic apparatus is capable of displaying, for example, state of cardiac beats and fetal movements in real time by a simple action of applying an ultrasonic probe to a body surface. Also, the ultrasonic diagnostic apparatus, which is highly safe from X-ray or other radiation exposure, allows repeated examinations. Furthermore, because of a smaller system scale than other medical apparatus such as an X-ray apparatus, X-ray CT (computed tomography) apparatus, MRI (magnetic resonance imaging) apparatus, and PET (positron emission tomography) apparatus, the ultrasonic diagnostic apparatus is convenient and easy to use, allowing, for example, bedside examinations to be conducted in a simple and easy manner. Because of such convenience, the ultrasonic diagnostic apparatus is used widely today for the heart, abdomen, and urinary organs as well as in gynecology and the like.

With conventional techniques, in the case of an operation mode change from B mode to a mode which involves processing an area of interest (such as color Doppler mode which involves processing an ROI (region of interest)), position setting and fine adjustments of the area of interest are required after the operation mode change, complicating operator actions.

Also, mode display on a display unit and an input unit used for the operation mode change are located in different places, requiring the operator to remember the location of the input unit and taking some getting used to.

### BRIEF DESCRIPTION OF THE DRAWINGS

In accompanying drawings,

FIG. 1 is a block diagram showing an overall configuration of an ultrasonic diagnostic apparatus according to a first embodiment;

FIG. 2 is a block diagram showing a detailed configuration of a transmit and receive unit and a data generating unit in the ultrasonic diagnostic apparatus according to the first embodiment;

FIG. 3 is a block diagram showing functions of the ultrasonic diagnostic apparatus according to the first embodiment;

FIG. 4 is an imaginary diagram showing an action on a B-mode image with the ultrasonic diagnostic apparatus according to the first embodiment;

FIG. 5 is an imaginary diagram showing an action on a Doppler spectrum image with the ultrasonic diagnostic apparatus according to the first embodiment;

FIG. 6 is an imaginary diagram showing an action on a color Doppler image with the ultrasonic diagnostic apparatus according to the first embodiment;

FIGS. 7A-7D are diagrams for explaining a first example of position setting and operation mode setting in a B-mode image;

FIG. 8 is a diagram for explaining how to change a set position;

FIGS. 9A-9D are diagrams for explaining a second example of position setting and operation mode setting in a B-mode image;

FIG. 10 is a diagram for explaining how to change a set position;

FIGS. 11A-11D are diagrams for explaining a third example of position setting and operation mode setting in a B-mode image;

FIG. 12 is a diagram for explaining how to change a set position;

FIGS. 13A-13F are diagrams showing a first variation of the operation mode selection method;

FIGS. 14A and 14B are diagrams showing a second variation of the operation mode selection method;

FIG. 15 is a diagram showing a third variation of the operation mode selection method;

FIG. 16 is a diagram showing a fourth variation of the operation mode selection method;

FIG. 17 a diagram showing a first variation of the mode selection menu;

FIG. 18 is a diagram showing a second variation of the mode selection menu;

FIG. 19 is a diagram showing a third variation of the mode selection menu;

FIG. 20 is a diagram showing a fourth variation of the mode selection menu;

FIG. 21 is a diagram showing a fifth variation of the mode selection menu;

FIGS. 22A and 22B are diagrams showing a sixth variation of the mode selection menu;

FIG. 23 is a diagram showing a variation of the display position of the mode selection menu;

FIG. 24 is a diagram showing an example of a freeze button;

FIG. 25 is a diagram showing an example of an action selection menu;

FIGS. 26A and 26B are diagrams for explaining a fourth example of position setting and operation mode setting in a B-mode image;

FIGS. 27A and 27B are diagrams for explaining a fifth example of position setting and operation mode setting in a B-mode image;

FIG. 28 is a flowchart showing an example of operation of the ultrasonic diagnostic apparatus according to the first embodiment;

FIG. 29 is a block diagram showing an overall configuration of an ultrasonic diagnostic apparatus according to a second embodiment;

FIG. 30 is a block diagram showing functions of the ultrasonic diagnostic apparatus according to the second embodiment;

FIG. 31 is an imaginary diagram showing an action on a B-mode image with the ultrasonic diagnostic apparatus according to the second embodiment;

FIG. 32 is an imaginary diagram showing an action on a Doppler spectrum image with the ultrasonic diagnostic apparatus according to the second embodiment;

FIG. 33 is a block diagram showing an overall configuration of a diagnostic imaging apparatus according to the present embodiment;

FIG. 34 is a block diagram showing functions of the diagnostic imaging apparatus according to the present embodiment;

FIG. 35 is a block diagram showing an overall configuration of an image processing apparatus according to the present embodiment; and

FIG. 36 is a block diagram showing functions of the image processing apparatus according to the present embodiment.

### DETAILED DESCRIPTION

An ultrasonic diagnostic apparatus, a diagnostic imaging apparatus, an image processing apparatus, and a program stored in a non-transitory computer-readable recording medium executed by a computer according to the present embodiment will be described with reference to the accompanying drawings.

To solve the above-described problems, the present embodiments provide the ultrasonic diagnostic apparatus equipped with a display unit configured to display an ultrasonic image, including: a controller configured to execute a setting for a position of an area of interest in the displayed ultrasonic image and a displaying of a mode selection menu on the display unit, simultaneously, in response to a single action while the ultrasonic image is displayed on the display unit.

To solve the above-described problems, the present embodiments provide the diagnostic imaging apparatus equipped with a display unit configured to display a medical image, including: a controller configured to execute a setting for a position of an area of interest in the displayed medical image and a displaying of a mode selection menu on the display unit, simultaneously, in response to a single action while the medical image is displayed on the display unit.

To solve the above-described problems, the present embodiments provide the image processing apparatus equipped with a display unit configured to display a medical image, including: a controller configured to execute a setting for a position of an area of interest in the displayed medical image and a displaying of a mode selection menu on the display unit, simultaneously, in response to a single action while the medical image is displayed on the display unit.

To solve the above-described problems, the present embodiments provide the program stored in a non-transitory computer-readable recording medium executed by a computer, including: displaying a medical image on a display unit; and executing a setting for a position of an area of interest in the displayed medical image and a displaying of a mode selection menu on the display unit, simultaneously, in response to a single action while the medical image is displayed on the display unit.

The ultrasonic diagnostic apparatus, the diagnostic imaging apparatus, the image processing apparatus, and the program according to the present embodiment allows the operator to select a mode in a simple and easy manner, thereby reducing examination times.

### First Embodiment

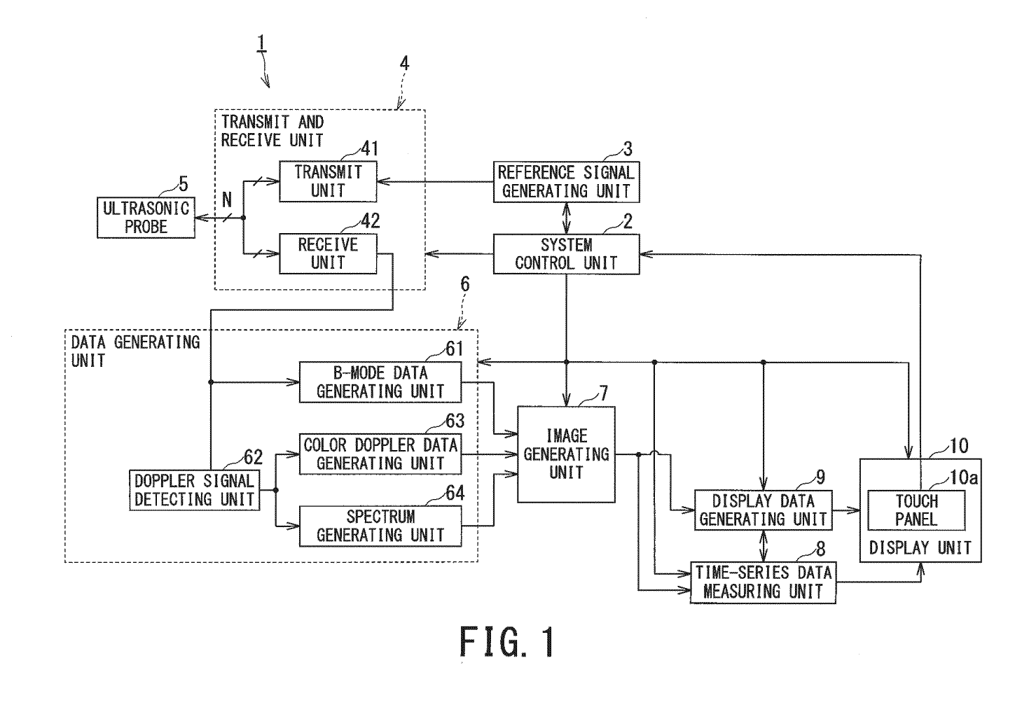

FIG. 1 is a block diagram showing an overall configuration of an ultrasonic diagnostic apparatus according to a first embodiment.

FIG. 1 shows the ultrasonic diagnostic apparatus 1 according to the first embodiment. The ultrasonic diagnostic apparatus 1 includes a system control unit 2, a reference signal generating unit 3, a transmit and receive unit 4, an ultrasonic probe 5, a data generating unit 6, an image generating unit 7, a time-series data measuring unit 8, a display data generating unit 9, and a display unit 10.

The system control unit 2 includes a CPU (central processing unit) and a memory. The system control unit 2 executes overall control of all units of the ultrasonic diagnostic apparatus 1.

The reference signal generating unit 3 generates, for example, a continuous wave or square wave with a frequency approximately equal to a center frequency of an ultrasonic pulse for the transmit and receive unit 4 and data generating unit 6 based on a control signal from the system control unit 2.

The transmit and receive unit 4 executes transmission and reception with respect to the ultrasonic probe 5. The transmit and receive unit 4 includes a transmit unit 41 adapted to generate a drive signal for radiating transmitted ultrasonic wave from the ultrasonic probe 5 and a receive unit 42 adapted to execute phasing addition of received signals from the ultrasonic probe 5.

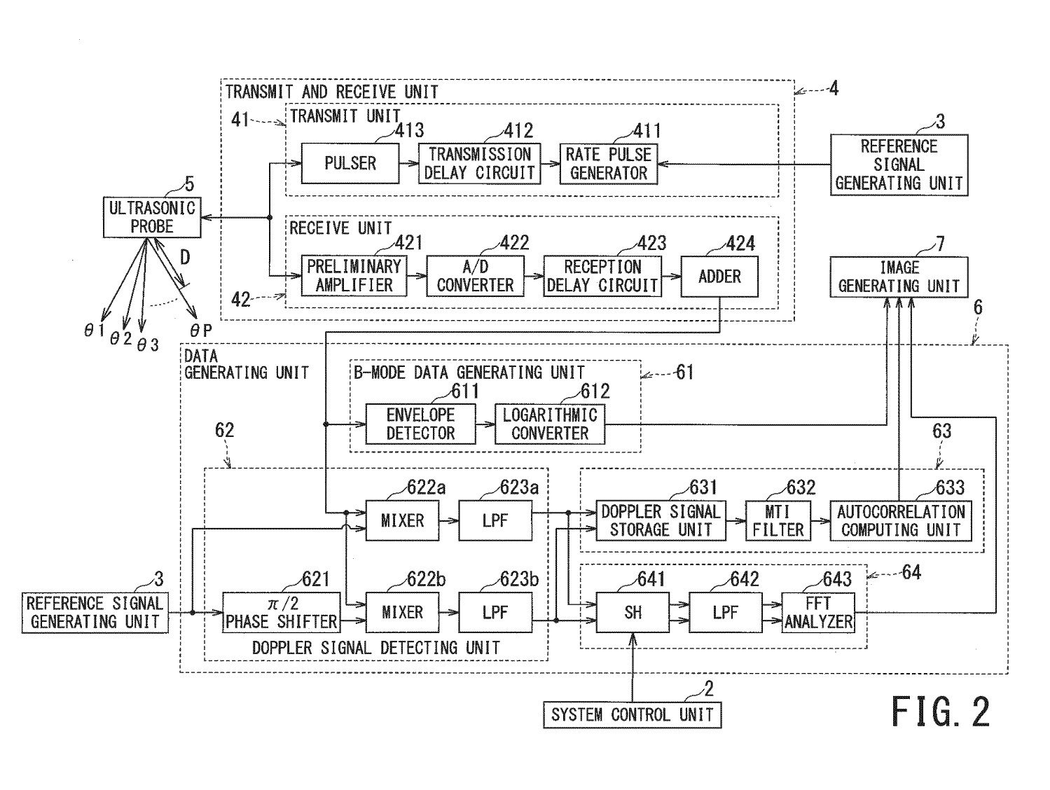

FIG. 2 is a block diagram showing a detailed configuration of the transmit and receive unit 4 and data generating unit 6 in the ultrasonic diagnostic apparatus 1 according to the first embodiment.

As shown in FIG. 2, the transmit unit 41 includes a rate pulse generator 411, a transmission delay circuit 412, and a pulser 413. The rate pulse generator 411 generates a rate pulse which determines a cycle period of transmitted ultrasonic wave, by frequency-dividing a continuous wave or square wave supplied from the reference signal generating unit 3 and supplies the rate pulse to the transmission delay circuit 412.

The transmission delay circuit 412, which is made up of the same number (N channels) of independent delay circuits as ultrasonic transducers used for transmission, gives the rate pulse a delay time intended to converge transmitted ultrasonic wave to a predetermined depth to obtain a thin beam width as well as a delay time intended to radiate transmitted ultrasonic wave in a predetermined direction and supplies the rate pulse to the pulser 413 in transmission.

The pulser 413 has independent drive circuits of N channels and generates drive pulses, based on the rate pulse, to drive ultrasonic transducers built in the ultrasonic probe 5.

Returning to FIG. 1, the ultrasonic probe 5 transmits and receives ultrasonic wave to/from an object. The ultrasonic probe 5, which is designed to transmit and receive ultrasonic wave with its front face placed in contact with a surface of the object, has plural (N) minute ultrasonic transducers arranged one-dimensionally in its distal portion.

The ultrasonic transducers, which are electroacoustic transducers, have a function to convert electrical pulses into ultrasonic pulses (transmitted ultrasonic wave) at the time of transmission and convert reflected ultrasonic wave (received ultrasonic wave) into an electrical signal (received signal) at the time of reception.

The ultrasonic probe 5 is configured to be compact and lightweight and is connected to the transmit unit 41 and receive unit 42 of the transmit and receive unit 4 via a cable. The ultrasonic probe 5 supports sector scanning, linear scanning, convex scanning, and the like, one of which is selected freely depending on a diagnostic site. An ultrasonic probe 5 which supports sector scanning for cardiac function measurement will be described below, but the present invention is not limited to this method, and an ultrasonic probe which supports linear scanning or convex scanning may be used as well.

The receive unit 42 includes a preliminary amplifier 421, an A/D (analog to digital) converter 422, a reception delay circuit 423, and an adder 424 as shown in FIG. 2. The preliminary amplifier 421, which has N channels, is configured to secure a sufficient signal-to-noise ratio by amplifying weak signals converted into electrical received signals by the ultrasonic transducers. After being amplified to a predetermined magnitude by the preliminary amplifier 421, the received signals on the N channels are converted into digital signals by the A/D converter 422 and sent to the reception delay circuit 423.

The reception delay circuit 423 gives a convergence delay time intended to converge reflected ultrasonic wave from a predetermined depth as well as a deflection delay time intended to set receive directivity in a predetermined direction to each of the received signal on the N channels outputted from the A/D converter 422.

The adder 424 executes phasing addition (addition of the received signals obtained from a predetermined direction by matching the phase) of the signals received from the reception delay circuit 423.

Returning to FIG. 1, the data generating unit 6 generates B-mode data, color Doppler data, and a Doppler spectrum based on a received signal obtained from the transmit and receive unit 4.

The data generating unit 6 includes a B-mode data generating unit 61, a Doppler signal detecting unit 62, a color Doppler data generating unit 63, and a spectrum generating unit 64 as shown in FIG. 2.

The B-mode data generating unit 61 generates B-mode data for the received signal outputted from the adder 424 of the receive unit 42. The B-mode data generating unit 61 includes an envelope detector 611 and a logarithmic converter 612. The envelope detector 611 demodulates the received signal subjected to phasing addition and supplied from the adder 424 of the receive unit 42 and an amplitude of the demodulated signal is logarithmically converted by the logarithmic converter 612.

The Doppler signal detecting unit 62 detects a Doppler signal in the received signal using quadrature detection. The Doppler signal detecting unit 62 includes a n/2 phase shifter 621, mixers 622a, 622b, and LPFs (low-pass filters) 623a, 623b. The Doppler signal detecting unit 62 detects a Doppler signal in the received signal supplied from the adder 424 of the receive unit 42 using quadrature phase detection.

The color Doppler data generating unit 63 generates color Doppler data based on the detected Doppler signal. The color Doppler data generating unit 63 includes a Doppler signal storage unit 631, a MTI (moving target indicator) filter 632, and an autocorrelation computing unit 633. The Doppler signal from the Doppler signal detecting unit 62 is saved once in the Doppler signal storage unit 631.

The MTI filter 632, which is a high-pass digital filter, reads the Doppler signal out of the Doppler signal storage unit 631 and removes Doppler components (clutter components) from the Doppler signal, the Doppler components stemming from respiratory movements, pulsatile movements, or the like of organs.

The autocorrelation computing unit 633 calculates an autocorrelation value of the Doppler signal from which only blood flow information has been extracted by the MTI filter 632 and then calculates an average flow velocity value and variance value based on the autocorrelation value.

The spectrum generating unit 64 executes FFT analysis of the Doppler signal detected by the Doppler signal detecting unit 62 and generates a frequency spectrum (Doppler spectrum) of the Doppler signal. The spectrum generating unit 64 includes an SH (sample-and-hold) circuit 641, an LPF (low-pass filter) 642, and an FFT (fast-fourier-transform) analyzer 643. Note that each of the SH circuit 641 and LPF 642 is made up of two channels, and that a complex component of the Doppler signal outputted from the Doppler signal detecting unit 62 is supplied to each channel, where the complex component is made up of a real component (I component) and imaginary component (Q component).

The SH circuit 641 is supplied with Doppler signals outputted from the LPFs 623a and 623b of the Doppler signal detecting unit 62 as well as with a sampling pulse (range gate pulse) generated by the system control unit 2 by frequency-dividing a reference signal of the reference signal generating unit 3. The SH circuit 641 samples and holds a Doppler signal from a desired depth D using a sampling pulse. Note that the sampling pulse is produced after a delay time Ts following a rate pulse which determines timing to radiate transmitted ultrasonic wave, where the delay time Ts can be set as desired.

The LPF 642 removes a stepwise noise component superposed on a Doppler signal having a depth D and outputted from the SH circuit 641.

The FFT analyzer 643 generates a Doppler spectrum based on a smoothed Doppler signal supplied. The FFT analyzer 643 includes an arithmetic circuit and storage circuit (neither is shown). The Doppler signal outputted from the LPF 642 is saved once in the storage circuit. The arithmetic circuit generates a Doppler spectrum by executing FFT analysis of a series of Doppler signals saved in the storage circuit, during predetermined intervals of the Doppler signals.

Returning to FIG. 1, the image generating unit 7 saves the B-mode data and color Doppler data obtained by the data generating unit 6, by putting the B-mode data and color Doppler data in correspondence with each other in a scanning direction, thereby generating B-mode images and color Doppler images, which are ultrasonic images, in the form of data. Also, the image generating unit 7 saves Doppler spectra and B-mode data obtained in a predetermined scanning direction, in time sequence, thereby generating Doppler spectrum images and M-mode images, which are ultrasonic images, in the form of data.

The image generating unit 7 sequentially saves B-mode data and color Doppler data classified according to the scanning direction and thereby generates B-mode images and color Doppler images, where the B-mode data and color Doppler data are generated by the data generating unit 6, for example, based on the received signals obtained by transmitting and receiving ultrasonic wave in scanning directions θ1 to θP. Furthermore, the image generating unit 7 generates M-mode images by saving B-mode data in time sequence and generates Doppler spectrum images by saving Doppler spectra in time sequence, where the B-mode data is obtained through multiple times of ultrasonic transmission and reception in a desired scanning direction θp (p=1, 2, . . . , P) and the Doppler spectra are based on received signals obtained from a distance D in the scanning direction θp through similar ultrasonic transmission and reception. That is, plural B-mode images and color Doppler images are saved in an image data storage area of the image generating unit 7 and M-mode images and Doppler spectrum images are saved in a time-series data storage area.

The time-series data measuring unit 8 reads time-series data for a predetermined period out of the image generating unit 7 and measures diagnostic parameters such as a velocity trace based on the time-series data.

The display data generating unit 9 generates display data in a predetermined display format by combining the ultrasonic images generated by the image generating unit 7 and measurement values of the diagnostic parameters measured by the time-series data measuring unit 8.

The display unit 10 displays display data generated by the display data generating unit 9. The display unit 10 includes a conversion circuit and a display unit (display) (neither is shown) as well as a touch panel 10a. The conversion circuit generates a video signal by applying D/A conversion and TV format conversion to the display data generated by the display data generating unit 9, and displays the display data on the display. The touch panel 10a is provided on a display surface of the display by arranging plural touch sensors (not shown).

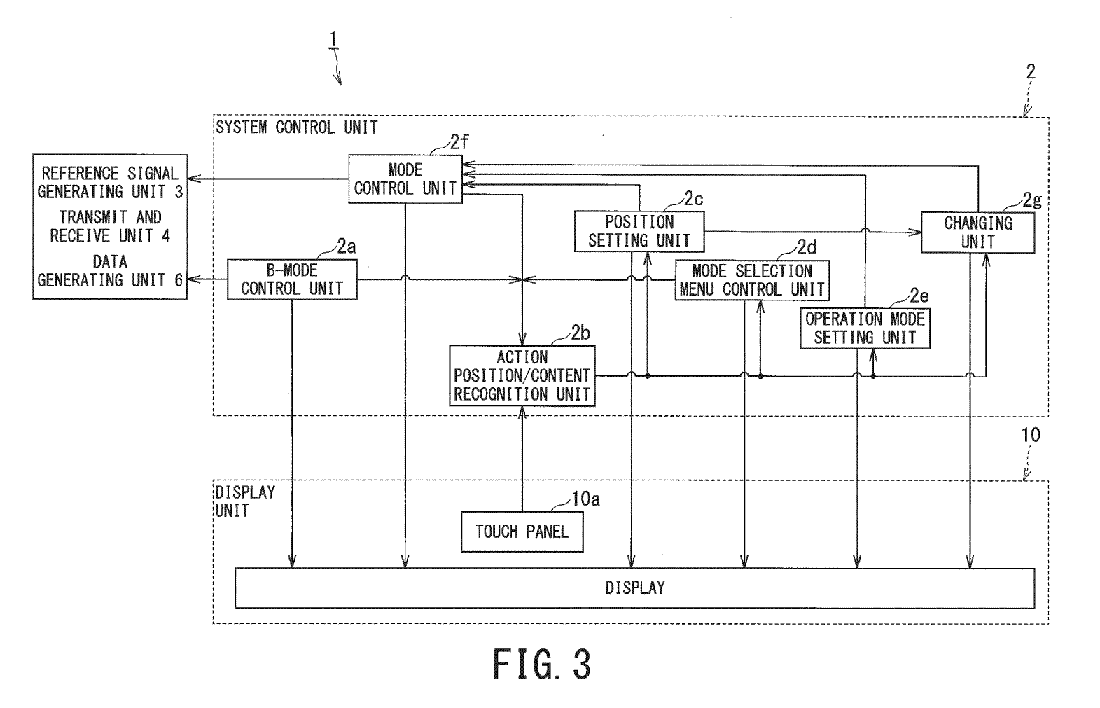

FIG. 3 is a block diagram showing functions of the ultrasonic diagnostic apparatus 1 according to the first embodiment.

As the system control unit 2 shown in FIG. 1 executes a program, the ultrasonic diagnostic apparatus 1 functions as a B-mode control unit 2a, an acting position/content recognition unit 2b, a position setting unit 2c, a mode selection menu control unit 2d, an operation mode setting unit 2e, a mode control unit 2f, and a changing unit 2g.

The B-mode control unit 2a has a function to make the image generating unit 7 (shown in FIGS. 1 and 2) generate B-mode images, by controlling the reference signal generating unit 3, transmit and receive unit 4, and data generating unit 6. Also, the B-mode control unit 2a has a function to display the B-mode images generated by the image generating unit 7 on the display of the display unit 10 via the display data generating unit 9 (shown in FIG. 1).

The acting position/content recognition unit 2b has a function to recognize an acting position (such as a press position, release position, stop position after moving from the press position, or release position after moving from the press position) sent from the touch panel 10a while the display of the display unit 10 is displaying a medical image such as an ultrasonic image (B-mode image provided by the B-mode control unit 2a, or color Doppler image, M-mode image, or Doppler spectrum image displayed by the mode control unit 2f) or a mode selection menu provided by the mode selection menu control unit 2d as well as to recognize an action content (such as a tap action, double tap action, slide action, flick action, or pinch action). Based on acting position information sent from the touch panel 10a and information about the time at which the acting position information is received, the acting position/content recognition unit 2b distinguishes which action the operator intends to perform on a display screen, a tap action, double tap action, slide action, flick action, or pinch action.

The tap action, which is performed by an operator's finger or a stylus, involves pressing and releasing the display once. The double tap action involves pressing and releasing the display twice successively. The slide action involves placing an operator's finger or a stylus on the display, moving the finger or stylus in an arbitrary direction in contact with the display, and then stopping the movement. The flick action involves pressing an operator's finger or a stylus on the display and then releasing the display by flicking it with the finger or stylus in an arbitrary direction. The pinch action involves pressing operator's two fingers or the like simultaneously against the display, and then moving the two fingers or the like in contact with the display so as to split them before stopping or so as to close them before stopping. In this case, the action of splitting the pressed two fingers or the like is referred to as a pinch-out action while the action of closing the pressed two fingers or the like is referred to as a pinch-in action, in particular. Note that the slide action and flick action involve pressing the operator's finger(s) or the like against the display and moving it/them on the display (tracing over the display) and can be known from two types of information—moving distance and moving direction—although the actions differ in movement speed.

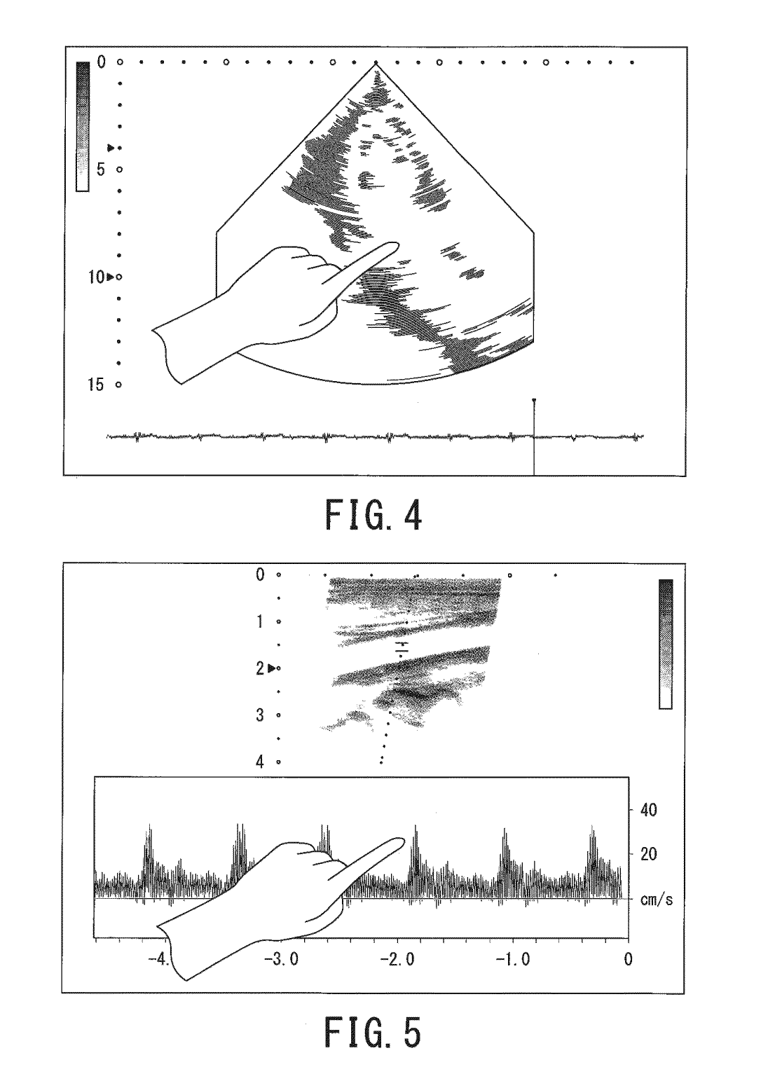

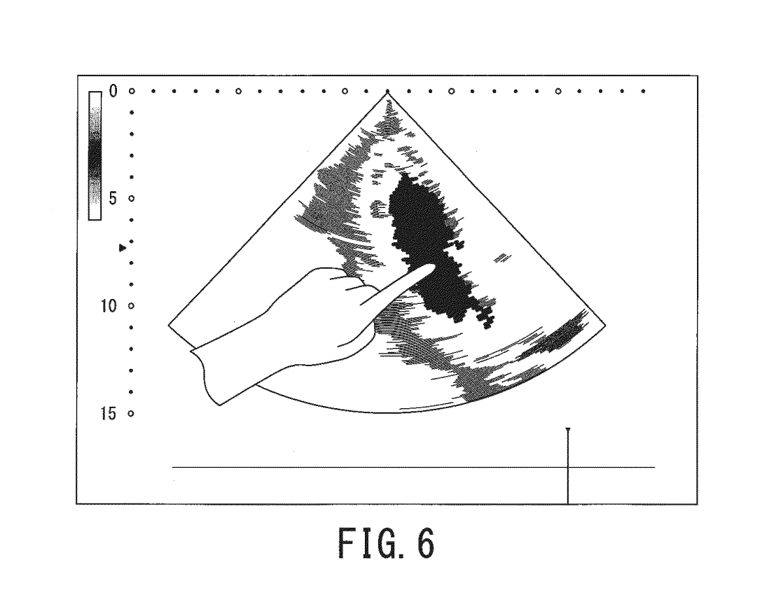

FIG. 4 is an imaginary diagram showing an action on a B-mode image with the ultrasonic diagnostic apparatus 1 according to the first embodiment. FIG. 5 is an imaginary diagram showing an action on a Doppler spectrum image with the ultrasonic diagnostic apparatus 1 according to the first embodiment. FIG. 6 is an imaginary diagram showing an action on a color Doppler image with the ultrasonic diagnostic apparatus 1 according to the first embodiment.

Returning to FIG. 3, while a medical image such as an ultrasonic image is displayed on the display of the display unit 10, if a tap action with a press position (or release position) being located in the ultrasonic image is recognized by the acting position/content recognition unit 2b, the position setting unit 2c serves a function of setting a press position of a tap action as a location (center position) of an area of interest in the ultrasonic image. For example, the position setting unit 2c makes position settings for a range gate, ROI (region of interest), caliper, and the like serving as areas of interest in a B-mode image. Also, for example, the position setting unit 2c makes position settings for a start point (or end point) in a Doppler spectrum image. Desirably, the set position in the ultrasonic image is displayed on the display of the display unit 10.

While a medical image such as an ultrasonic image is displayed on the display of the display unit 10, if a tap action with a press position (or release position) being located in the ultrasonic image is recognized by the acting position/content recognition unit 2b, the mode selection menu control unit 2d serves a function of displaying the mode selection menu centering on the press position of the tap action on the display of the display unit 10.

That is, while an ultrasonic image is displayed on the display, the position setting unit 2c and mode selection menu control unit 2d execute a setting for a position of an area of interest in the displayed ultrasonic image and a displaying of the mode selection menu on the display, simultaneously, in response to a single action.

While the mode selection menu is displayed on the display of the display unit 10, if a tap action with a press position being located in a button of the mode selection menu is recognized by the acting position/content recognition unit 2b, the operation mode setting unit 2e serves a function of selecting and setting an operation mode corresponding to the button as a required operation mode.

The mode control unit 2f has a function to make the image generating unit 7 (shown in FIGS. 1 and 2) generate a color Doppler image, M-mode image, or Doppler spectrum image, by controlling the reference signal generating unit 3, transmit and receive unit 4, and data generating unit 6 according to the set position established in the ultrasonic image by the position setting unit 2c and the operation mode set by the operation mode setting unit 2e. Also, the mode control unit 2f has a function to display the color Doppler image, M-mode image, or Doppler spectrum image generated by the image generating unit 7, on the display of the display unit 10 via the display data generating unit 9 (shown in FIG. 1)

When a slide (flick) action with a press position being located at an area-of-interest position set by the position setting unit 2c is recognized, the changing unit 2g serves a function of changing the set position of the area of interest to a stop position of the slide action (a release position of the flick action). Also, when a pinch action with a press position being located at the set position of an ROI is recognized, the changing unit 2g serves a function of changing a preset size of the ROI to a stop position of the pinch action, where the ROI is an area of interest and the set position of the ROI has been established by the position setting unit 2c. Desirably, the position of the area of interest after the change is displayed on the display of the display unit 10. Note that once the set position of the area of interest is changed by the changing unit 2g, the mode control unit 2f makes the image generating unit 7 (shown in FIG. 1 and FIG. 2) generate a color Doppler image, M-mode image, or Doppler spectrum image, by controlling the reference signal generating unit 3, transmit and receive unit 4, and data generating unit 6 according to the operation mode set by the operation mode setting unit 2e and the position of the area of interest after the change made by the changing unit 2g.

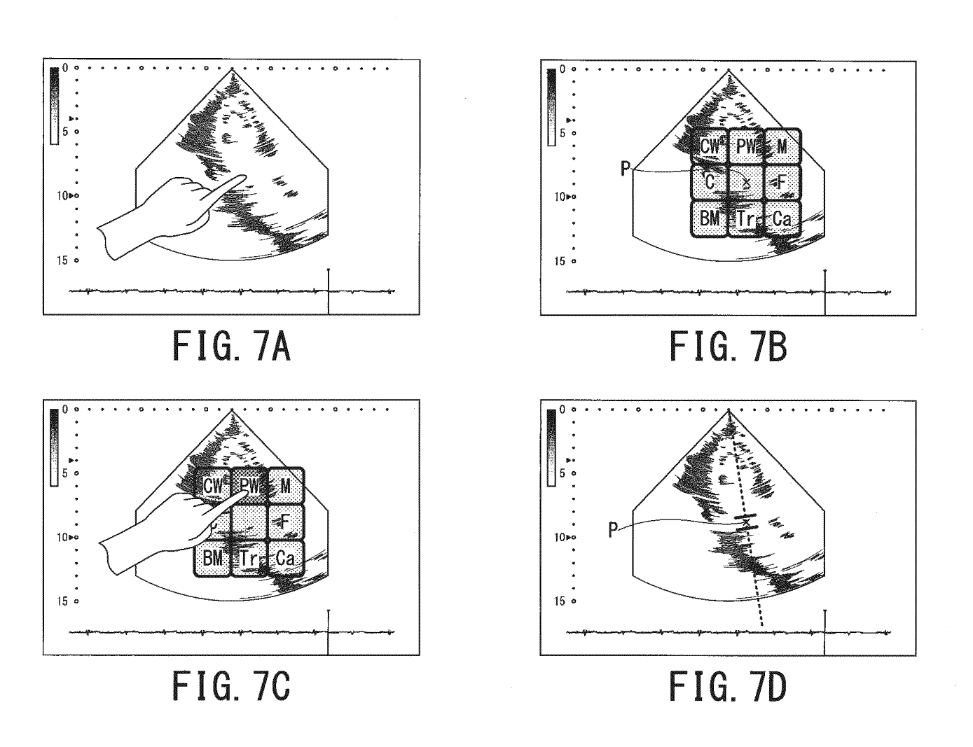

Now the functions of components ranging from the acting position/content recognition unit 2b to the changing unit 2g will be described with reference to FIGS. 7A-12.

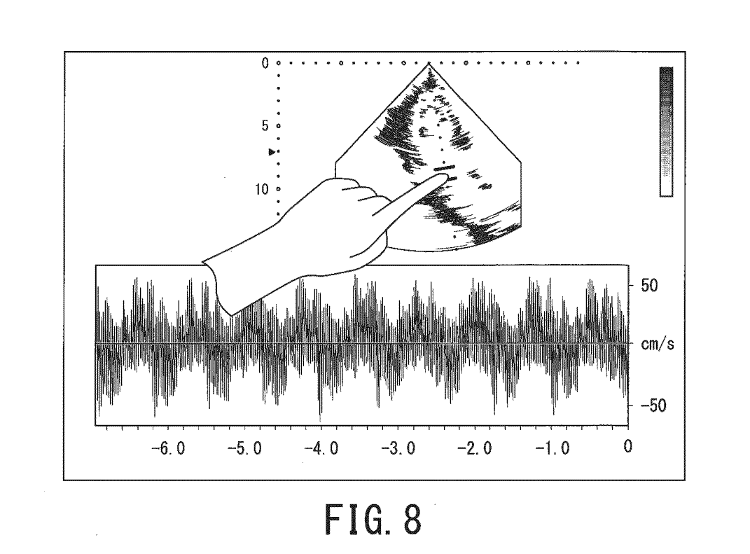

FIGS. 7A-7D are diagrams for explaining a first example of position setting and operation mode setting in a B-mode image. FIG. 8 is a diagram for explaining how to change a set position.

FIG. 7A is a diagram showing a state just before the acting position/content recognition unit 2b recognizes a tap action with a press position being located in a B-mode image while the B-mode image is displayed. FIG. 7B is a diagram showing a display state next to the state shown in FIG. 7A, the display state being brought about by the position setting unit 2c and mode selection menu control unit 2d right after the acting position/content recognition unit 2b recognizes the tap action with the press position being located in the B-mode image. As shown in FIG. 7B, the mode selection menu is displayed, centering on the press position P of the tap action recognized by the acting position/content recognition unit 2b. Desirably, a layer of the mode selection menu displayed in front of the B-mode image is translucent so that the B-mode image behind the menu can be seen through the menu.

FIG. 7C is a diagram showing a display state next to the state shown in FIG. 7B, the display state being brought about by the operation mode setting unit 2e right after the acting position/content recognition unit 2b recognizes a tap action with a press position being located in a button of an operation mode (pulse Doppler mode: “P_{W}”) on the mode selection menu. As shown in FIG. 7C, the button of the operation mode (pulse Doppler mode: “PW”) corresponding to the press position of the tap action recognized by the acting position/content recognition unit 2b is displayed in a display format (color, size, shape, and the like) different from buttons of other operation modes.

After the state shown in FIG. 7B, when the acting position/content recognition unit 2b recognizes a tap action with a press position being located in the B-mode image but outside the buttons of the mode selection menu, the mode selection menu centering on the press position P shown in FIG. 7B switches to the mode selection menu centering on the press position outside the buttons.

FIG. 7D is a diagram showing a display state brought about after FIG. 7C. Here, the press position P of the tap action recognized by the acting position/content recognition unit 2b is set as an initial position of a range gate in the pulse Doppler mode.

FIG. 8 is a diagram showing a display of a Doppler spectrum image occurring after the state shown in FIG. 7D and concerning the position of the range gate set by the position setting unit 2c and measured in the pulse Doppler mode set by the operation mode setting unit 2e. In the display shown in FIG. 8, when the acting position/content recognition unit 2b recognizes a slide action with a press position being located on the range gate, the changing unit 2g changes the position of the range gate to the stop position of the slide action.

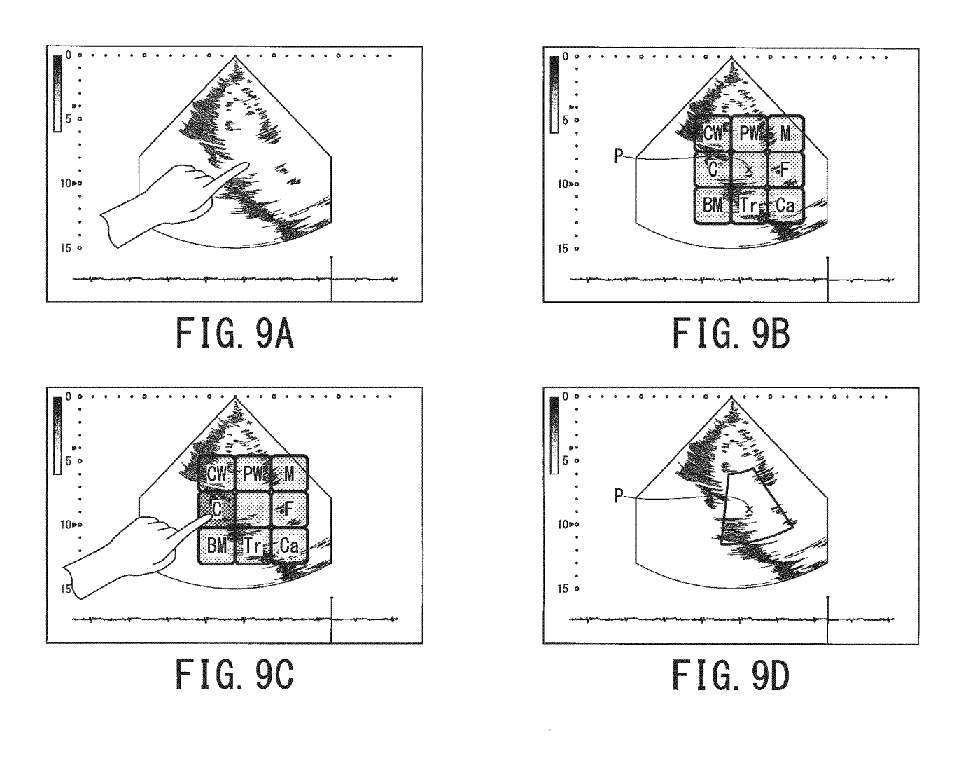

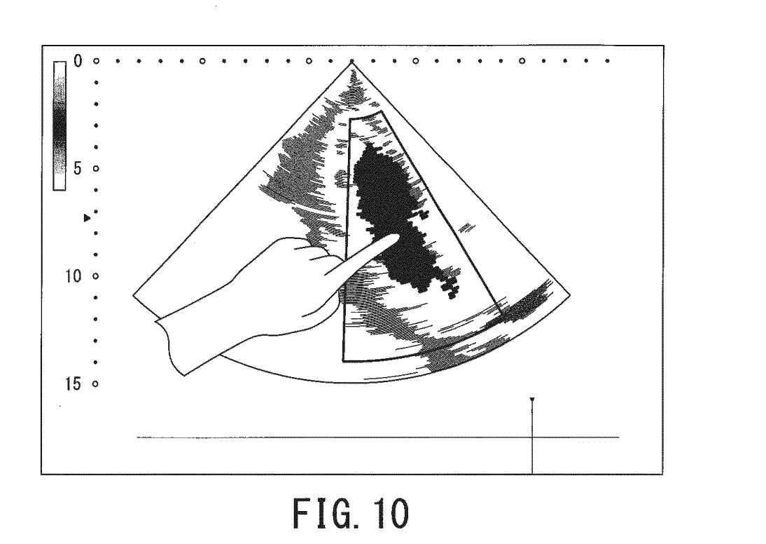

FIGS. 9A-9D are diagrams for explaining a second example of position setting and operation mode setting in a B-mode image. FIG. 10 is a diagram for explaining how to change a set position.

FIG. 9A is a diagram showing a state just before the acting position/content recognition unit 2b recognizes a tap action with a press position being located in a B-mode image while the B-mode image is displayed. FIG. 9B is a diagram showing a display state next to the state shown in FIG. 9A, the display state being brought about by the position setting unit 2c and mode selection menu control unit 2d right after the acting position/content recognition unit 2b recognizes the tap action with the press position being located in the B-mode image. As shown in FIG. 9B, the mode selection menu is displayed, centering on the press position P of the tap action recognized by the acting position/content recognition unit 2b. Desirably, the layer of the mode selection menu displayed in front of the B-mode image is translucent so that the B-mode image behind the menu can be seen through the menu.

FIG. 9C is a diagram showing a display state next to the state shown in FIG. 9B, the display state being brought about by the operation mode setting unit 2e right after the acting position/content recognition unit 2b recognizes a tap action with a press position being located in a button of an operation mode (color Doppler mode: “C”) on the mode selection menu. As shown in FIG. 9C, the button of the operation mode (color Doppler mode: “C”) corresponding to the press position of tap action recognized by the acting position/content recognition unit 2b is displayed in a display format different from the buttons of the other operation modes.

After the state shown in FIG. 9B, when the acting position/content recognition unit 2b recognizes a tap action with a press position being located in the B-mode image but outside the buttons of the mode selection menu, the mode selection menu centering on the press position P shown in FIG. 9B switches to the mode selection menu centering on the press position outside the buttons.

FIG. 9D is a diagram showing a display state brought about after FIG. 9C. Here, the press position P of the tap action recognized by the acting position/content recognition unit 2b is set as an initial position of an ROI in the color Doppler mode.

FIG. 10 is a diagram showing a display of a color Doppler image occurring after the state shown in FIG. 9D and concerning the position of the ROI set by the position setting unit 2c and measured in the color Doppler mode set by the operation mode setting unit 2e. In the display shown in FIG. 10, when the acting position/content recognition unit 2b recognizes a slide action with a press position being located on the ROI, the changing unit 2g changes the position of the ROI to the stop position of the slide action. On the other hand, when the acting position/content recognition unit 2b recognizes a pinch action with a press position being located on the ROI, the changing unit 2g changes the size of the ROI to the stop position of the pinch action.

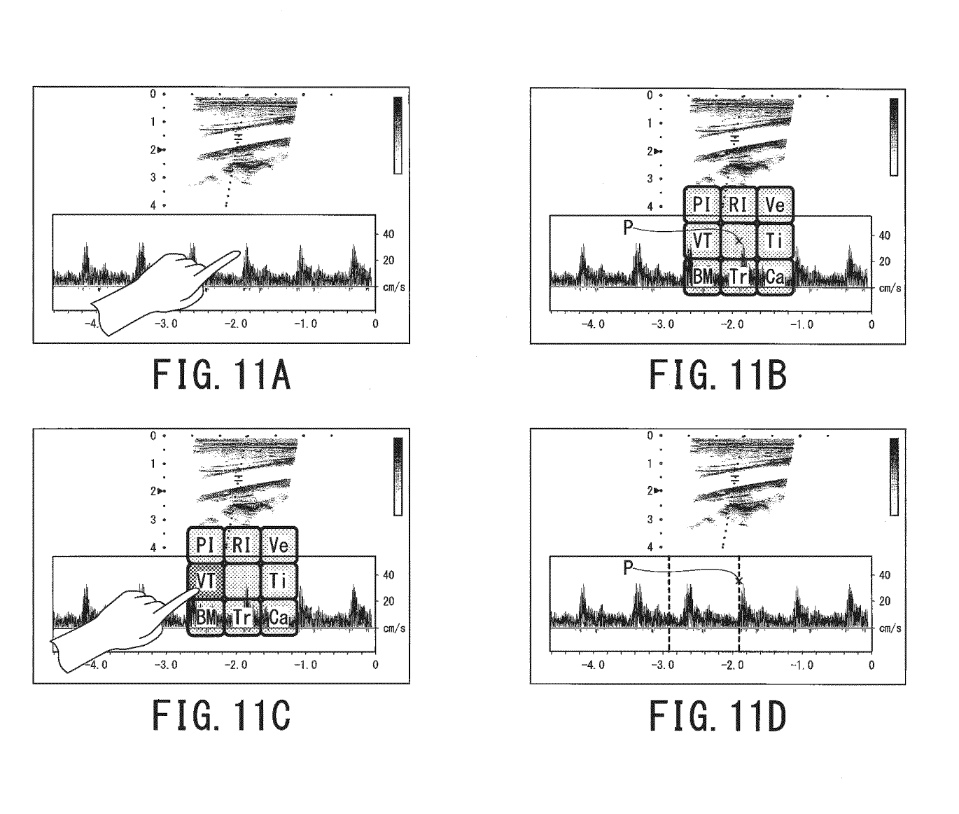

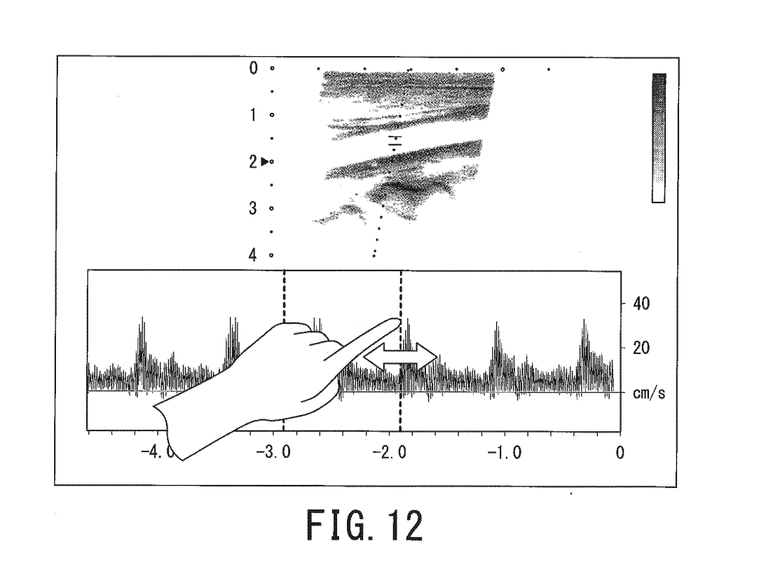

FIGS. 11A-11D are diagrams for explaining a third example of position setting and operation mode setting in a B-mode image. FIG. 12 is a diagram for explaining how to change a set position.

Note that although FIGS. 11A-11D and FIG. 12 show examples of switching from B-mode to pulse Doppler mode, this is not restrictive. For example, switching may be done from color Doppler mode to pulse Doppler mode. In that case, when the acting position/content recognition unit 2b recognizes a tap action with a press position being located at a backflow position in the color Doppler image and then recognizes a tap action with a press position being located in a button of continuous wave display mode (“CW”) on the mode selection menu brought about by the first tap action, a blood flow rate at the recognized backflow position is measured by the time-series data measuring unit 8 (shown in FIG. 1).

FIG. 11A is a diagram showing a state just before the acting position/content recognition unit 2b recognizes a tap action with a press position being located in a Doppler spectrum image while the Doppler spectrum image is displayed. FIG. 11B is a diagram showing a display state next to the state shown in FIG. 11A, the display state being brought about by the position setting unit 2c and mode selection menu control unit 2d right after the acting position/content recognition unit 2b recognizes the tap action with the press position being located in the Doppler spectrum image. As shown in FIG. 11B, the mode selection menu is displayed, centering on the press position P of the tap action recognized by the acting position/content recognition unit 2b. Desirably, the layer of the mode selection menu displayed in front of the Doppler spectrum image is translucent so that the Doppler spectrum image behind the menu can be seen through the menu.

FIG. 11C is a diagram showing a display state next to the state shown in FIG. 11B, the display state being brought about by the operation mode setting unit 2e right after the acting position/content recognition unit 2b recognizes a tap action with a press position being located in a button of an operation mode (velocity trace mode: “VT”) on the mode selection menu. As shown in FIG. 11C, the button of the operation mode (velocity trace mode: “VT”) corresponding to the press position of tap action recognized by the acting position/content recognition unit 2b is displayed in a display format different from the buttons of the other operation modes.

After the state shown in FIG. 11B, when the acting position/content recognition unit 2b recognizes a tap action with a press position being located in the Doppler spectrum image but outside the buttons of the mode selection menu, the mode selection menu centering on the press position P shown in FIG. 11B switches to the mode selection menu centering on the press position outside the buttons.

FIG. 11D is a diagram showing a display state brought about after FIG. 11C. Here, the press position of the tap action recognized by the acting position/content recognition unit 2b is set as an initial position of a start point (or end point) of velocity trace. Next, when the acting position/content recognition unit 2b recognizes a tap action with a press position being located in the Doppler spectrum image, the press position is set as the initial position of the end point (or start point) of the velocity trace.

FIG. 12 is a diagram showing a display of a Doppler spectrum image occurring after the state shown in FIG. 11D and concerning the positions of the start point and end point set by the position setting unit 2c and measured in the pulse Doppler mode set by the operation mode setting unit 2e. In the display shown in FIG. 12, when the acting position/content recognition unit 2b recognizes a slide action with a press position being located at the start point (or end point), the changing unit 2g changes the position of the start point (or end point) to the stop position of the slide action.

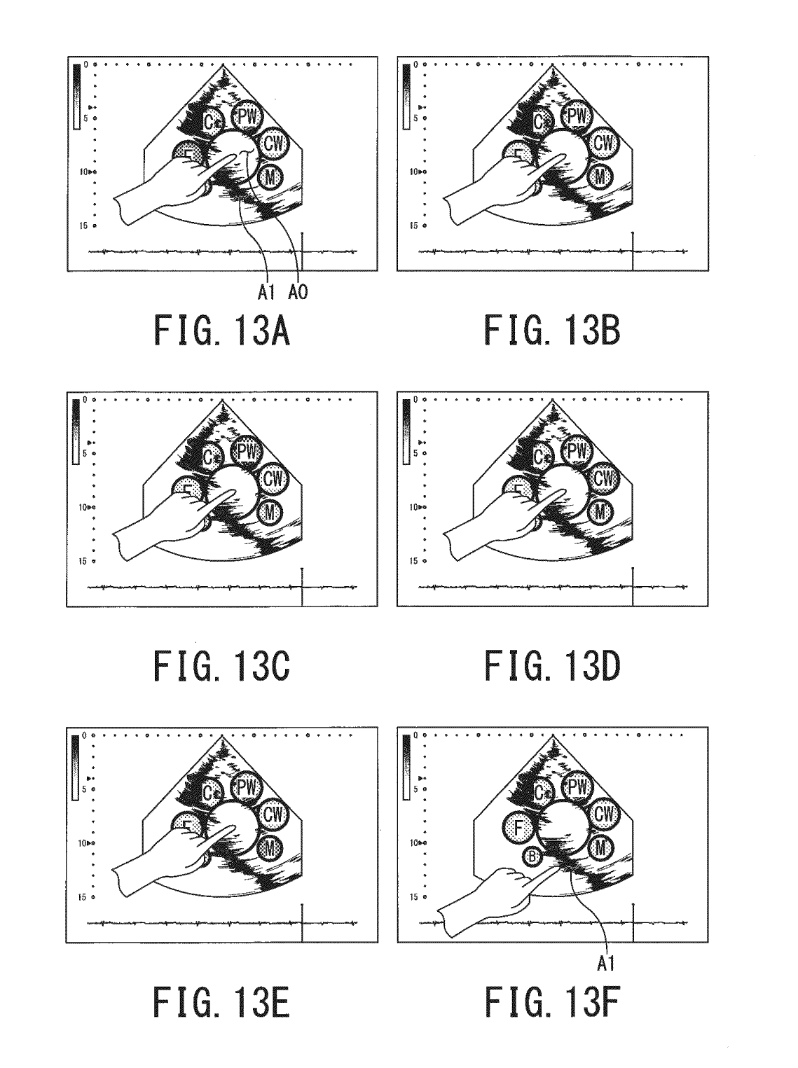

FIGS. 13A-13F are diagrams showing a first variation of the operation mode selection method.

FIGS. 13A-13F show a mode selection menu including a blank region A0 and centering on the press position of a tap action and plural operation mode buttons arranged around the blank region A0, representing choices. A blank region A1 is also provided at a corner around the blank region A0 and when the acting position/content recognition unit 2b recognizes a tap action with a press position being located in the blank region A1, mode selection mode can be exited by terminating the display of the mode selection menu without selecting any operation mode.

In the display shown in FIG. 13A, when the acting position/content recognition unit 2b recognizes a tap action with a press position being located in the blank region A0, a different display format is moved from a button of operation mode “F” to a button of “C” as shown in FIG. 13B. Furthermore, in the display shown in FIG. 13B, when the acting position/content recognition unit 2b recognizes a tap action with a press position being located in the blank region A0, a different display format is moved from a button of operation mode “C” to a button of “PW” as shown in FIG. 13C. Furthermore, in the display shown in FIG. 13C, when the acting position/content recognition unit 2b recognizes a tap action with a press position being located in the blank region A0, a different display format is moved from a button of operation mode “PW” to a button of “CW” as shown in FIG. 13D. Furthermore, in the display shown in FIG. 13D, when the acting position/content recognition unit 2b recognizes a tap action with a press position being located in the blank region A0, a different display format is moved from a button of operation mode “CW” to a button of “M” as shown in FIG. 13E. When the acting position/content recognition unit 2b recognizes a tap action with a press position being located in the blank region A1 shown in FIG. 13P, the mode selection mode is exited by terminating the display of the mode selection menu without selecting any operation mode.

With the operation mode selection method shown in FIGS. 13A-13F, selected buttons change sequentially.

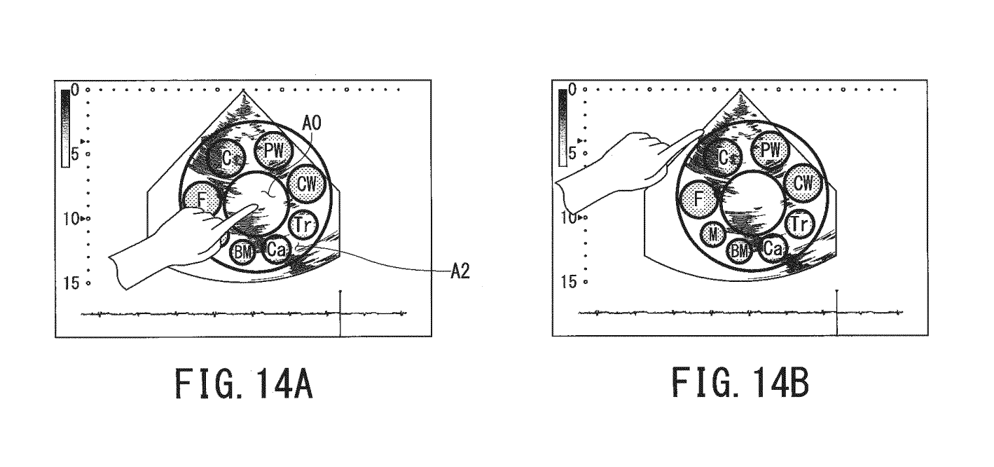

While an ultrasonic image is displayed on the display of the display unit 10, if the acting position/content recognition unit 2b recognizes not only a tap action with a press position being located in the ultrasonic image, but also a slide action or flick action with a press position being located in the ultrasonic image, the position setting unit 2c may set the press position of the slide action as the position (center position) of an area of interest in the ultrasonic image. This will be described with reference to FIGS. 14A-16.

FIGS. 14A and 14B are diagrams showing a second variation of the operation mode selection method.

FIGS. 14A and 14B show a mode selection menu including a blank region A0 and centering on a press position of a slide action performed with the press position being located in a B-mode image, a response region A2 (hidden) around the blank region A0, and plural operation mode buttons arranged in the response region A2, representing choices. Also, FIGS. 14A and 14B show a mode selection menu including a blank region A0 and centering on a press position of a flick action performed with the press position being located in a B-mode image, a response region A2 (hidden) around the blank region A0, and plural operation mode buttons arranged in the response region A2, representing choices.

When the acting position/content recognition unit 2b recognizes a slide action with a press position being located in the B-mode image, the mode selection menu shown in FIG. 14A is displayed. Next, the operation mode corresponding to the stop position of the slide action is selected. Alternatively, when the acting position/content recognition unit 2b recognizes a flick action with a press position being located in the B-mode image, the mode selection menu shown in FIG. 14A is displayed. Next, the operation mode corresponding to the release position of the flick action is selected. Note that when the stop position of the slide action or release position of the flick action is located outside the response region A2 as shown in FIG. 14B, the mode selection mode is exited by terminating the display of the mode selection menu without selecting any operation mode.

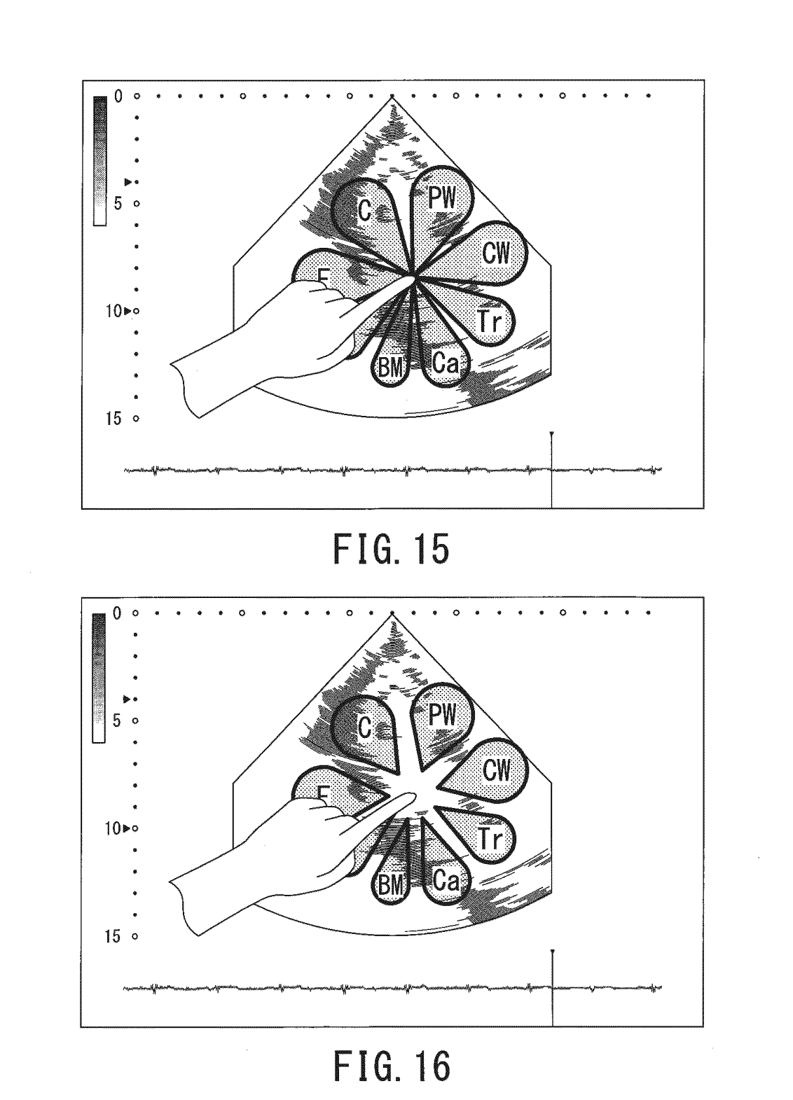

FIG. 15 is a diagram showing a third variation of the operation mode selection method. FIG. 16 is a diagram showing a fourth variation of the operation mode selection method.

FIG. 15 and FIG. 16 show a mode selection menu including plural operation mode buttons arranged around a press position of a slide action performed with the press position being located in a B-mode image, where the buttons represent choices. Alternatively, FIG. 15 and FIG. 16 show a mode selection menu including plural operation mode buttons arranged around a press position of a flick action performed with the press position being located in a B-mode image, where the buttons represent choices. Compared to the mode selection menu shown in FIG. 15, the mode selection menu shown in FIG. 16 is provided with a blank region around the press position of a tap action or slide (flick) action.

When the acting position/content recognition unit 2b recognizes a slide action with a press position being located in the B-mode image, the mode selection menu shown in FIG. 15 and FIG. 16 is displayed. Next, when the acting position/content recognition unit 2b recognizes a stop position in any of the buttons of the mode selection menu, the operation mode of the button at the stop position is selected.

Alternatively, when the acting position/content recognition unit 2b recognizes a flick action with a press position being located in the B-mode image, the mode selection menu shown in FIG. 15 and FIG. 16 is displayed. When the acting position/content recognition unit 2b recognizes a release position in any of the buttons of the mode selection menu, the operation mode of the button at the release position is selected.

The mode selection menu shown in FIGS. 15 and 16 allows button selection on the mode selection menu even if an amount of slide movement (distance between a press position and release position of a flick action) performed by the operator is small.

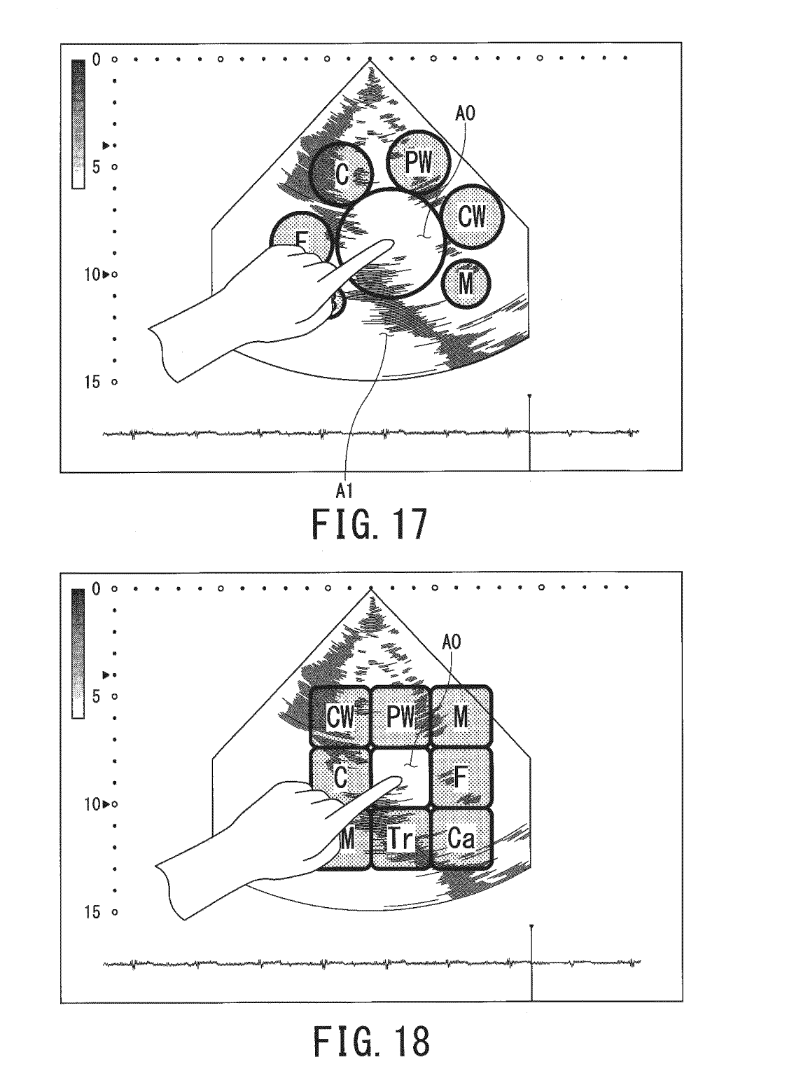

FIG. 17 is a diagram showing a first variation of the mode selection menu.

FIG. 17 shows a mode selection menu including a blank region A0 and centering on a press position of a tap action performed with the press position being located in a B-mode image and plural operation mode buttons arranged around the blank region A0, representing choices. The operation mode of the button at the press position of the tap action recognized by the acting position/content recognition unit 2b is selected from the mode selection menu. A blank region A1 is also provided at a corner around the blank region A0 and when the acting position/content recognition unit 2b recognizes a tap action with a press position being located in the blank region A1, the mode selection mode can be exited by terminating the display of the mode selection menu without selecting any operation mode.

With the operation mode selection method shown in FIGS. 13A-13F, when the acting position/content recognition unit 2b recognizes a tap action with a press position being located in the blank region A0, the button to be selected is switched. On the other hand, in the case of operation mode selection on the mode selection menu shown in FIG. 17, when the acting position/content recognition unit 2b recognizes a tap action with a press position being located in any of the buttons of the mode selection menu, the button is selected.

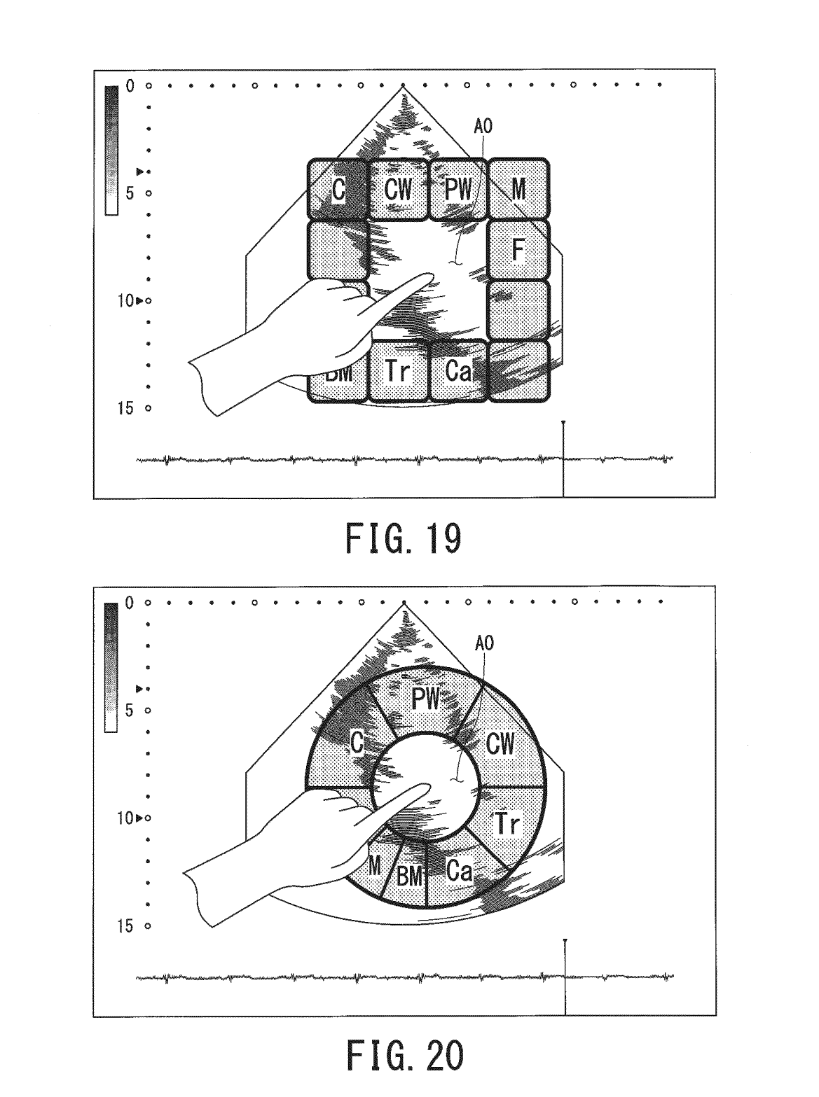

FIG. 18 is a diagram showing a second variation of the mode selection menu. FIG. 19 is a diagram showing a third variation of the mode selection menu. FIG. 20 is a diagram showing a fourth variation of the mode selection menu.

FIGS. 18-20 show a mode selection menu including a blank region A0 and centering on a press position of a tap action performed with the press position being located in a B-mode image and plural operation mode buttons arranged around the blank region A0, representing choices. The mode selection menu shown in FIGS. 18-20 allows the position of an area of interest in the ultrasonic image to be seen without being blocked by button display on the mode selection menu.

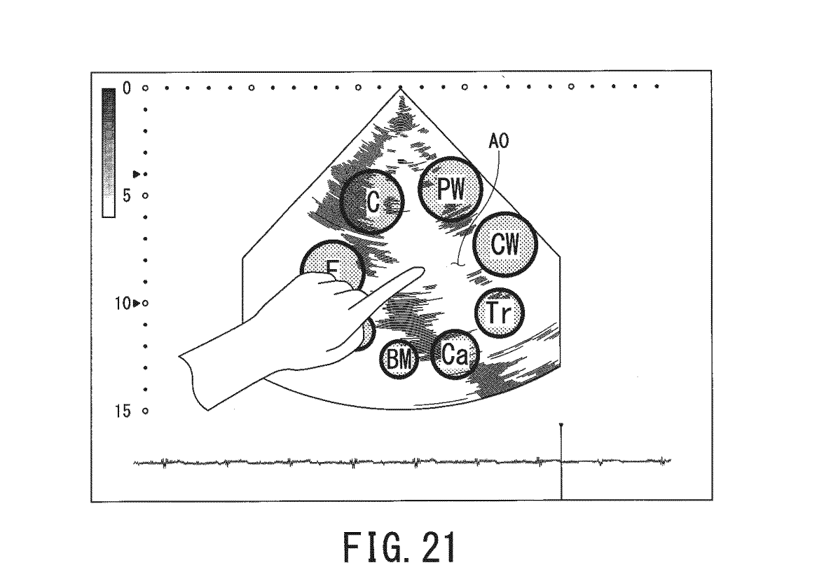

FIG. 21 is a diagram showing a fifth variation of the mode selection menu.

FIG. 21 shows a mode selection menu including a blank region A0 and centering on a press position of a tap action performed with the press position being located in a B-mode image and plural operation mode buttons arranged around the blank region A0, representing choices. On the mode selection menu shown in FIG. 21, the buttons are separate rather than continuous. Note that identification symbols on the operation menu are not limited to characters, and may be buttons or marks shaped to represent operation modes. The buttons do not need to be of equal size. The buttons may be varied in size according to display priority. Regarding content of the operation menu, locations of the buttons may be changed according to an operation workflow.

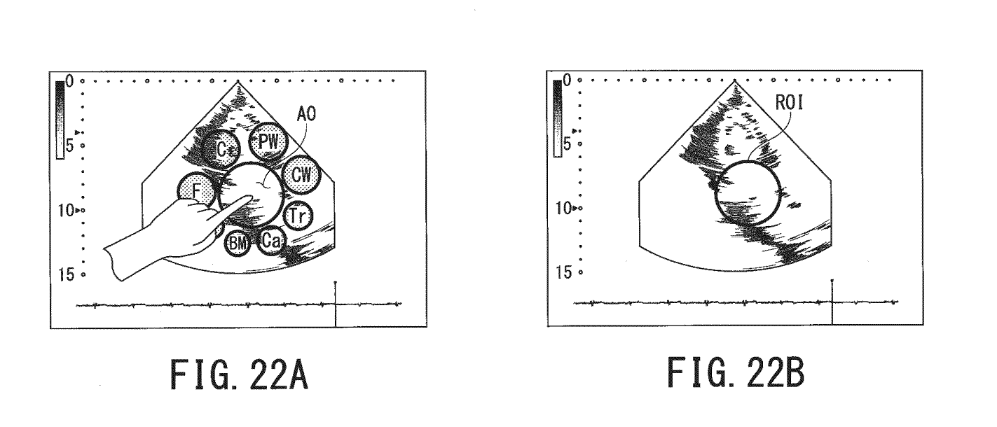

FIGS. 22A-22B are diagrams showing a sixth variation of the mode selection menu.

FIGS. 22A and 22B show a mode selection menu including a blank region A0 and centering on a press position of a tap action performed with the press position being located in a B-mode image and plural operation mode buttons arranged around the blank region A0, representing choices. Note that, as shown in FIG. 22B, the blank region A0 represents an ROI when the color Doppler mode is selected on the mode selection menu.

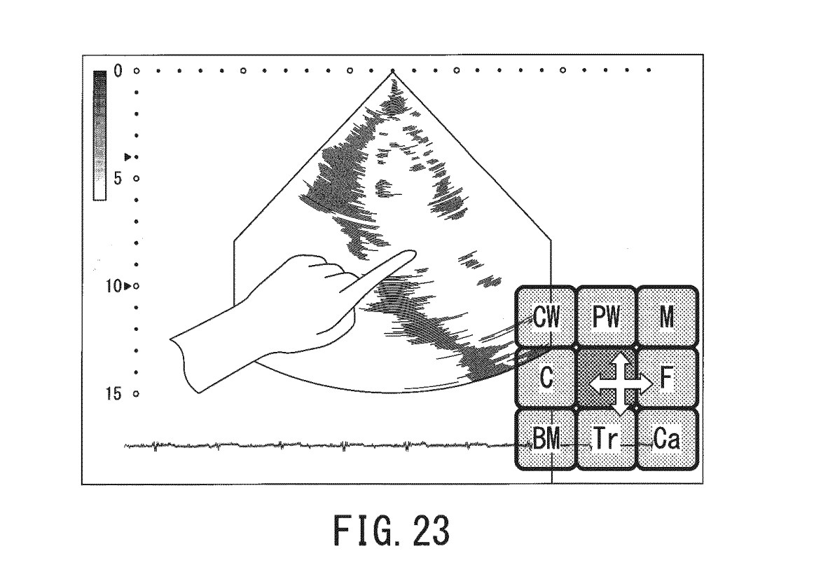

FIG. 23 is a diagram showing a variation of the display position of the mode selection menu.

Unlike those described in FIGS. 6-22B, FIG. 23 shows a mode selection menu brought up independently of a press position of a tap action performed with the press position being located in a B-mode image, the menu including plural operation mode buttons which represent choices. When the acting position/content recognition unit 2b recognizes a slide (flick) action with a press position being located at a predetermined position (e.g., a center) in the operation selection menu, the mode selection menu control unit 2d moves the display of the mode selection menu. Note that FIG. 23 may be a mode selection menu brought up independently of a press position of a slide (flick) action performed with the press position being located in a B-mode image, the menu including plural operation mode buttons which represent choices.

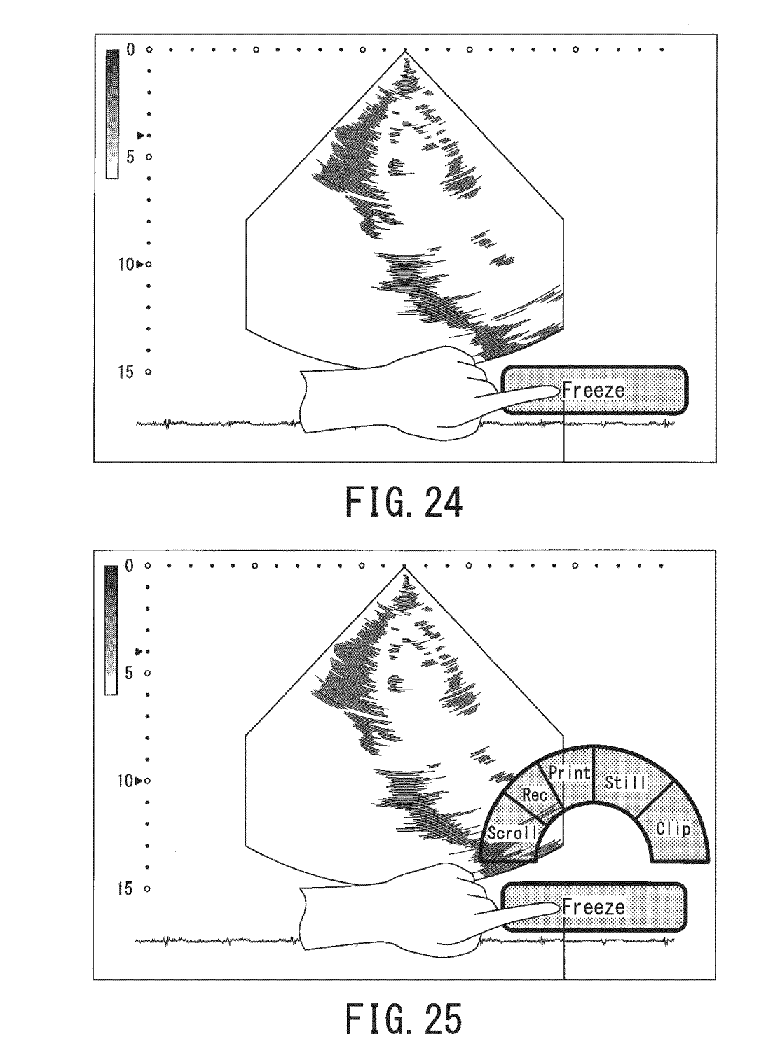

Also, the display unit 10 may display a freeze button to select a freeze mode and an action selection menu for use to select a print or other action to follow the freeze mode. This will be described with reference to FIGS. 24 and 25.

FIG. 24 is a diagram showing an example of the freeze button.

The freeze button is displayed as shown in FIG. 24. When the acting position/content recognition unit 2b recognizes a tap action with a press position being located in the freeze button, the freeze mode can be selected.

FIG. 25 is a diagram showing an example of the action selection menu.

The action selection menu for use to select an action to follow the freeze mode is displayed as shown in FIG. 25. When the acting position/content recognition unit 2b recognizes a tap action with a press position being located in any of the buttons of the action selection menu, the action corresponding to the button at the press position can be selected.

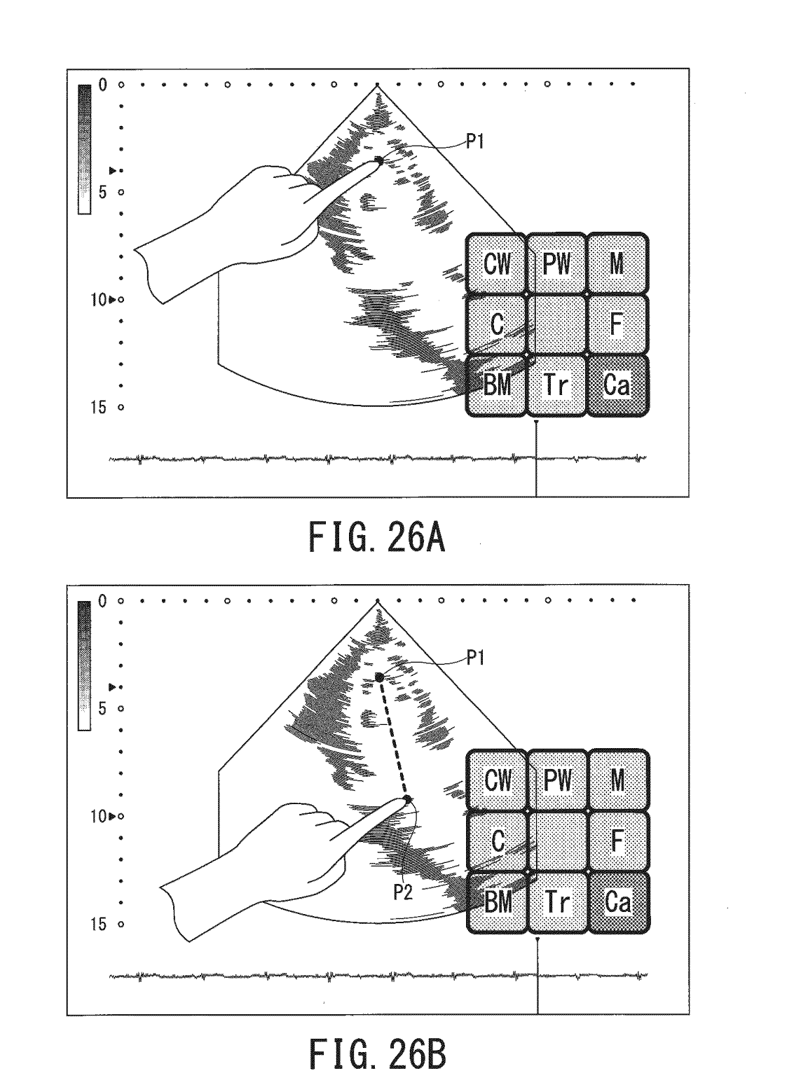

FIGS. 26A and 26B are diagrams for explaining a fourth example of position setting and operation mode setting in a B-mode image.

FIG. 26A is a diagram showing a display state brought about by the position setting unit 2c and mode selection menu control unit 2d during display of a medical image such as a frozen B-mode image right after the acting position/content recognition unit 2b recognizes a tap action with a first press position (first measuring caliper) P1 being located in the B-mode image. As shown in FIG. 26A, the mode selection menu is displayed regardless of a location of the first press position P1 of the tap action recognized by the acting position/content recognition unit 2b. Desirably, the layer of the mode selection menu displayed in front of the B-mode image is translucent so that the B-mode image behind the menu can be seen through the menu. Also, as shown in FIG. 26A, when the acting position/content recognition unit 2b recognizes a tap action with a press position being located in a button of an operation mode (caliper mode: “Ca”) on the mode selection menu, the button is displayed in a display format different from the buttons of the other operation modes.

Next, FIG. 26B is a diagram showing a display state brought about by the position setting unit 2c and mode selection menu control unit 2d during display of a frozen B-mode image right after the acting position/content recognition unit 2b recognizes a tap action with a second press position P2 being located in the B-mode image. When press positions P1 and P2 are confirmed, a distance (broken line in FIG. 26B) between the press positions P1 and P2 is set as a distance of a measurement site and distances and areas (volumes) are measured through image processing. Note that the mode selection menu may be hidden during tracing.

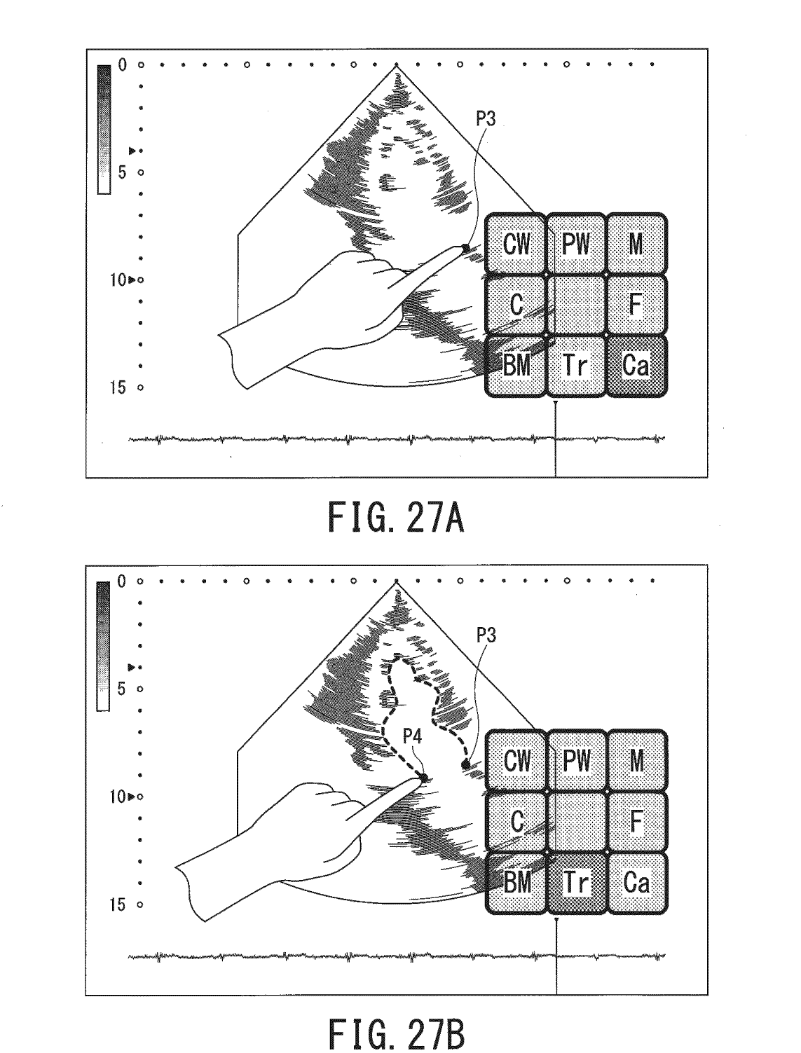

FIGS. 27A and 27B are diagrams for explaining a fifth example of position setting and operation mode setting in a B-mode image.

FIG. 27A is a diagram showing a display state brought about by the position setting unit 2c and mode selection menu control unit 2d during display of a medical image such as a B-mode image right after the acting position/content recognition unit 2b recognizes a tap action with a first press position (start point of tracing) P3 being located in the B-mode image. As shown in FIG. 27A, the mode selection menu is displayed regardless of a location of the first press position P3 of the tap action recognized by the acting position/content recognition unit 2b. Desirably, the layer of the mode selection menu displayed in front of the B-mode image is translucent so that the B-mode image behind the menu can be seen through the menu. Also, as shown in FIG. 27A, when the acting position/content recognition unit 2b recognizes a tap action with a press position being located in a button of an operation mode (trace mode: “Tr”) on the mode selection menu, the button is displayed in a display format different from the buttons of the other operation modes.

Next, FIG. 27B is a diagram showing a display state brought about by the position setting unit 2c and mode selection menu control unit 2d during display of a B-mode image right after the acting position/content recognition unit 2b recognizes a stop position P4 of a slide action (end point of tracing) with a press position being located at the first press position P3 (around the press position P3). When the press position P3, stop position P4, and tracing therebetween (broken line in FIG. 27B) are confirmed, a region defined by the press position P3, stop position P4, and tracing therebetween is set as an area of interest. Note that the mode selection menu may be hidden during tracing.

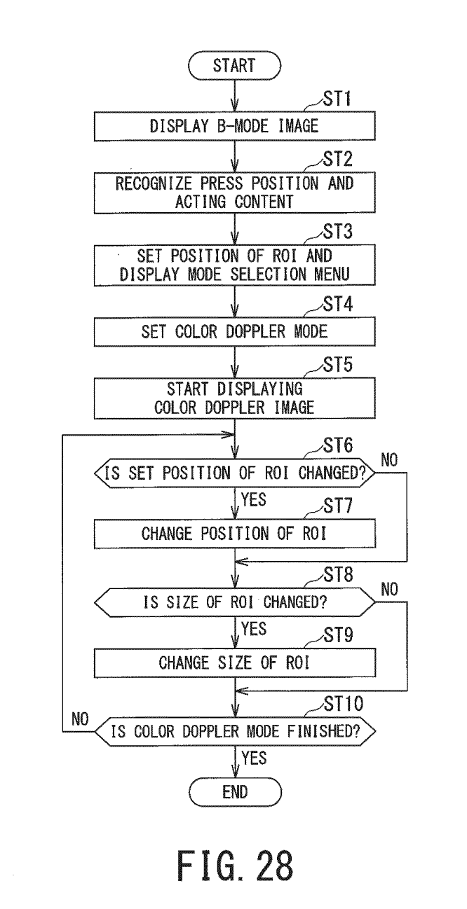

FIG. 28 is a flowchart showing an example of operation of the ultrasonic diagnostic apparatus 1 according to the first embodiment.

As shown in FIG. 28, by controlling the reference signal generating unit 3, transmit and receive unit 4, and data generating unit 6, the ultrasonic diagnostic apparatus 1 generates a B-mode image and displays the generated B-mode image on the display of the display unit 10 (step ST1). While the B-mode image is displayed on the display of the display unit 10, the ultrasonic diagnostic apparatus 1 recognizes press position information sent from the touch panel 10a and recognizes acting content information inputted (step ST2).

While the B-mode image is displayed on the display of the display unit 10, if a tap action with a press position being located in the B-mode image is recognized, the ultrasonic diagnostic apparatus 1 sets the press position as the position of an area of interest in the B-mode image and displays the mode selection menu on the display of the display unit 10, centering on the press position (step ST3). While the mode selection menu is displayed on the display of the display unit 10, if a tap action with a press position being located in any of the buttons of the mode selection menu is recognized, the ultrasonic diagnostic apparatus 1 sets the color Doppler mode at the press position as a required operation mode (step ST4).

By controlling the reference signal generating unit 3, transmit and receive unit 4, and data generating unit 6 according to the set position established in the B-mode image in step ST3 and the color Doppler mode set in step ST4, the ultrasonic diagnostic apparatus 1 generates a color Doppler image and starts displaying the generated color Doppler image on the display of the display unit 10 (step ST5). The ultrasonic diagnostic apparatus 1 determines whether a slide (flick) action has been recognized with a press position being located at a set position of an ROI established in the B-mode image in step ST3 (step ST6). That is, the ultrasonic diagnostic apparatus 1 determines in step ST6 whether to change the set position of the ROI established in the B-mode image in step ST3. If the determination in step ST6 is YES, i.e., if it is determined to change the set position of the ROI established in step ST3, the ultrasonic diagnostic apparatus 1 changes the set position of the ROI in the B-mode image to the stop position of the slide action (release position of the flick action) (step ST7).

Following a “NO” determination in step ST6 or after step ST7, the ultrasonic diagnostic apparatus 1 determines whether a pinch action has been recognized with a press position being located at the set position of the ROI established in the B-mode image in step ST3 (step ST8). That is, the ultrasonic diagnostic apparatus 1 determines in step ST8 whether to change the size of the ROI set beforehand in the B-mode image. If the determination in step ST8 is YES, i.e., if it is determined to change the size of the ROI set beforehand in the B-mode image, the ultrasonic diagnostic apparatus 1 changes the size of the ROI in the ultrasonic image to the stop position of the pinch action (step ST9).

Following a “NO” determination in step ST8 or after step ST9, the ultrasonic diagnostic apparatus 1 determines whether to finish the color Doppler mode selected in step ST4 (step ST10). If the determination in step ST10 is YES, i.e., if it is determined to finish the color Doppler mode, the ultrasonic diagnostic apparatus 1 finishes the color Doppler mode.

If the determination in step ST10 is NO, i.e., if it is determined not to finish the color Doppler mode, while continuing the color Doppler mode, the ultrasonic diagnostic apparatus 1 determines whether a slide (flick) action has been recognized with a press position being located at the set position of the ROI in the B-mode image (step ST6).

Since a setting for a position of an area of interest in a displayed ultrasonic image and a displaying of the mode selection menu on the display are executed, simultaneously, in response to a single action while the ultrasonic image is displayed on the display of the display unit 10, the ultrasonic diagnostic apparatus 1 according to the first embodiment can reduce operator actions, shorten the time required for the operator to get used to actions, and thereby allow the operator to select a mode in a simple and easy manner. Also, the ultrasonic diagnostic apparatus 1 according to the first embodiment allows examination times to be reduced.

### Second Embodiment

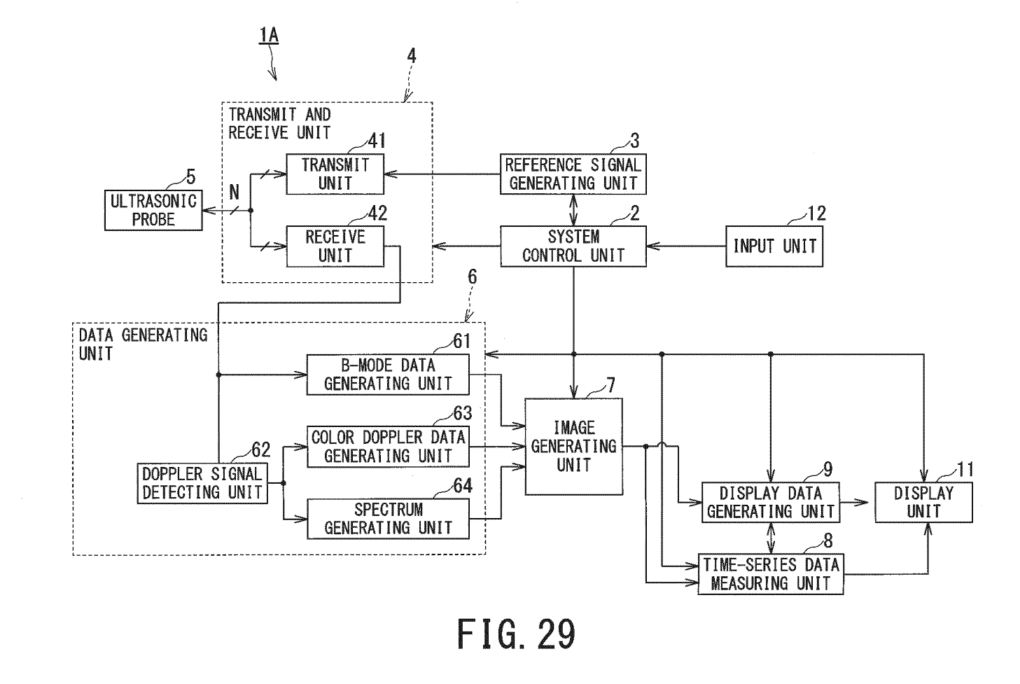

FIG. 29 is a block diagram showing an overall configuration of an ultrasonic diagnostic apparatus according to a second embodiment.

FIG. 29 shows the ultrasonic diagnostic apparatus 1A according to the second embodiment. The ultrasonic diagnostic apparatus 1A includes a system control unit 2, a reference signal generating unit 3, a transmit and receive unit 4, an ultrasonic probe 5, a data generating unit 6, an image generating unit 7, a time-series data measuring unit 8, a display data generating unit 9, a display unit 11, and an input unit 12. In FIG. 29, the same components as those in FIG. 1 are denoted by the same reference numerals as the corresponding components in FIG. 1, and description thereof will be omitted.

The display unit 11 displays display data generated by the display data generating unit 9. The display unit 11 includes a conversion circuit and a display unit (display) (neither is shown), but does not include a touch panel 10a unlike the display unit 10 shown in FIG. 1. The conversion circuit generates a video signal by applying D/A conversion and TV format conversion to the display data generated by the display data generating unit 9, and displays the display data on the display.

The input unit 12 includes input devices such as a keyboard, track ball, mouse, and select button, and allows actions to be performed with respect to the system control unit 2 in order to enter inputs.

A detailed configuration of the transmit and receive unit 4 and data generating unit 6 in the ultrasonic diagnostic apparatus 1A according to the second embodiment is similar to that shown in the block diagram of FIG. 2.

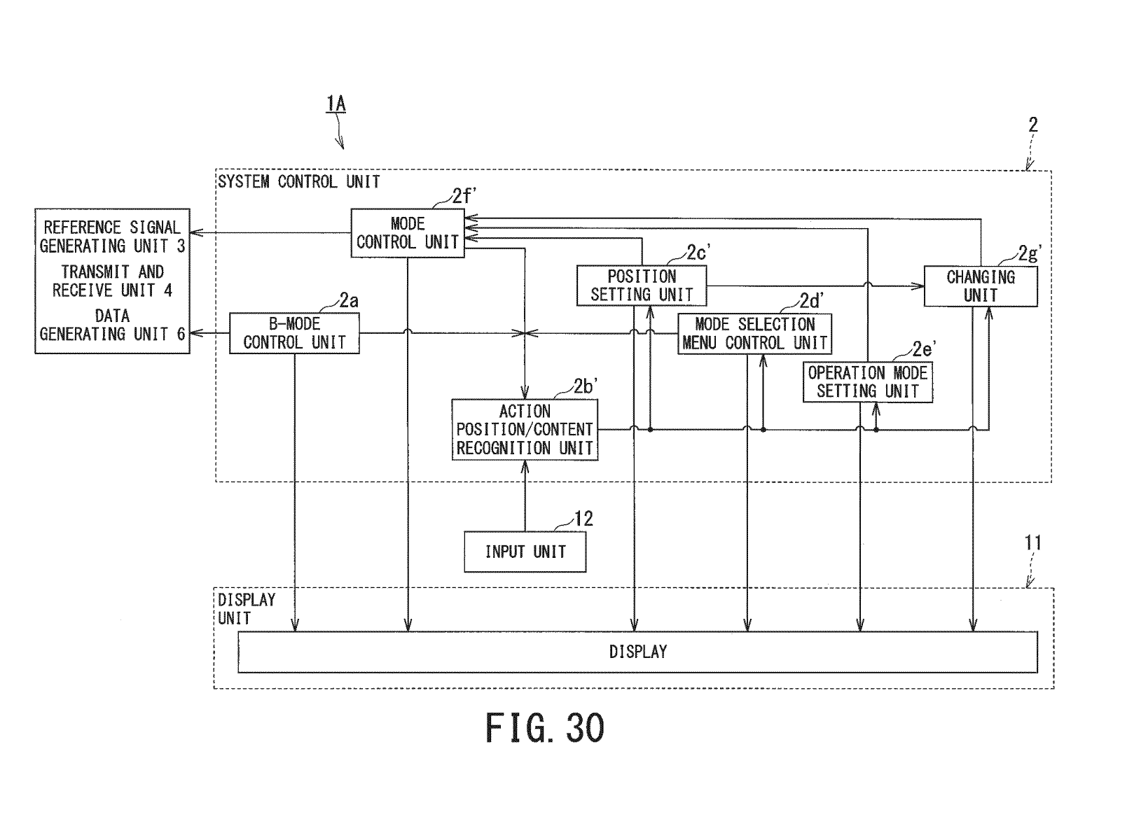

FIG. 30 is a block diagram showing functions of the ultrasonic diagnostic apparatus 1A according to the second embodiment.

As the system control unit 2 shown in FIG. 29 executes a program, the ultrasonic diagnostic apparatus 1A functions as a B-mode control unit 2a, an acting position/content recognition unit 2b′, a position setting unit 2c′, a mode selection menu control unit 2d′, an operation mode setting unit 2e′, a mode control unit 2f′, and a changing unit 2g′.

The acting position/content recognition unit 2b′ has a function to recognize an acting position (such as a hold-down position or a release position after holding) sent from the input unit 12 while the display of the display unit 11 is displaying an ultrasonic image (B-mode image provided by the B-mode control unit 2a, or color Doppler image, M-mode image, or Doppler spectrum image displayed by the mode control unit 2f′) or a mode selection menu provided by the mode selection menu control unit 2d′ as well as to recognize an action content (such as a click action, double click action, or drag action).

Based on acting position information sent from the input unit 12 and information about the time at which the acting position information is received, the acting position/content recognition unit 2b distinguishes which action the operator intends to perform, a click action, double click action, or drag action.

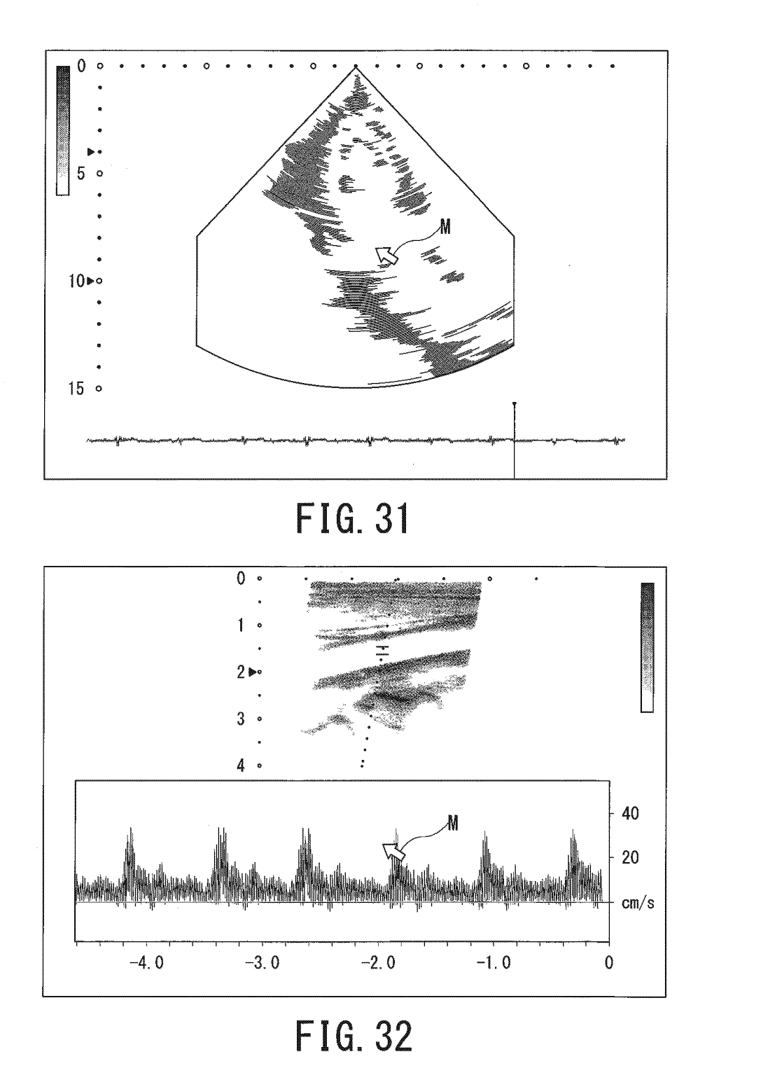

FIG. 31 is an imaginary diagram showing an action on a B-mode image with the ultrasonic diagnostic apparatus 1A according to the second embodiment. FIG. 32 is an imaginary diagram showing an action on a Doppler spectrum image with the ultrasonic diagnostic apparatus 1A according to the second embodiment.

Returning to FIG. 30, while an ultrasonic image is displayed on the display of the display unit 11, if a click action with a hold-down position (or release position) of a marker (pointer or cursor) M (shown in FIG. 31 and FIG. 32) being located in the ultrasonic image is recognized by the acting position/content recognition unit 2b′, the position setting unit 2c′ serves a function of setting a hold-down position of a click action as a location (center position) of an area of interest in the ultrasonic image. For example, the position setting unit 2c′ makes position settings for a range gate, ROI, caliper, and the like serving as areas of interest in a B-mode image. Also, for example, the position setting unit 2c′ makes position settings for a start point (or end point) in a Doppler spectrum image. Desirably, the set position in the ultrasonic image is displayed on the display of the display unit 11.

While an ultrasonic image is displayed on the display of the display unit 11, if a click action with a hold-down position (or release position) of a marker being located in the ultrasonic image is recognized by the acting position/content recognition unit 2b′, the mode selection menu control unit 2d′ serves a function of displaying the mode selection menu centering on the hold-down position of the click action on the display of the display unit 11.

That is, while an ultrasonic image is displayed on the display, the position setting unit 2c′ and mode selection menu control unit 2d′ execute a setting for a position of an area of interest in the displayed ultrasonic image and a displaying of the mode selection menu on the display, simultaneously, in response to a single action.

While the mode selection menu is displayed on the display of the display unit 11, if a click action with a hold-down position being located in the mode selection menu is recognized by the acting position/content recognition unit 2b′, the operation mode setting unit 2e′ serves a function of selecting and setting an operation mode corresponding to a button at the hold-down position of the click action as a required operation mode.

The mode control unit 2f′ has a function to make the image generating unit 7 (shown in FIG. 29) generate a color Doppler image, M-mode image, or Doppler spectrum image, by controlling the reference signal generating unit 3, transmit and receive unit 4, and data generating unit 6 according to the set position established in the ultrasonic image by the position setting unit 2c′ and the operation mode set by the operation mode setting unit 2e′. Also, the mode control unit 2f′ has a function to display the color Doppler image, M-mode image, or Doppler spectrum image generated by the image generating unit 7 on the display of the display unit 11 via the display data generating unit 9 (shown in FIG. 29).

When a drag action with a hold-down position being located at the position of an area of interest set by the position setting unit 2c′ is recognized, the changing unit 2g′ serves a function of changing the set position of the area of interest to the release position of the drag action. Also, when a drag action with a hold-down position being located at the set position of an ROI is recognized, the changing unit 2g′ serves a function of changing a preset size of the ROI to a release position of the drag action, where the ROI is an area of interest and the set position of the ROI has been established by the position setting unit 2c′. Desirably, the position of the area of interest after the change is displayed on the display of the display unit 11. Note that once the set position of the area of interest is changed by the changing unit 2g′, the mode control unit 2f′ makes the image generating unit 7 (shown in FIG. 29) generate a color Doppler image, M-mode image, or Doppler spectrum image, by controlling the reference signal generating unit 3, transmit and receive unit 4, and data generating unit 6 according to the operation mode set by the operation mode setting unit 2e′ and the position of the area of interest after the change made by the changing unit 2g′.

Note that the position setting in a B-mode image and operation mode setting shown in FIGS. 7A-12, FIGS. 26A and 26B, and FIGS. 27A and 27B, the operation mode selection method shown in FIGS. 13A-16, the mode selection menu shown in FIGS. 17-22B, the display position of the mode selection menu shown in FIG. 23, the freeze button shown in FIG. 24, the action selection menu shown in FIG. 25, and the operation of the ultrasonic diagnostic apparatus 1 according to the first embodiment shown in FIGS. 26A and 26B are also applicable to the ultrasonic diagnostic apparatus 1A according to the second embodiment.

Since a setting for a position of an area of interest in a displayed ultrasonic image and a displaying of the mode selection menu on the display are executed, simultaneously, in response to a single action while the ultrasonic image is displayed on the display of the display unit 11, the ultrasonic diagnostic apparatus 1A according to the second embodiment can reduce operator actions, shorten the time required for the operator to get used to actions, and thereby allow the operator to select a mode in a simple and easy manner. Also, the ultrasonic diagnostic apparatus 1A according to the second embodiment allows examination times to be reduced.

Note that the single action used to simultaneously make a position setting for an area of interest in the displayed ultrasonic image and display the mode selection menu on the display may be allowed to be carried out from any of the touch panel 10a and input unit 12 by combining the configuration of the ultrasonic diagnostic apparatus 1 according to the first embodiment and the configuration of the ultrasonic diagnostic apparatus 1A according to the second embodiment with each other.

Note that the application of the configurations which provide the above effects is not limited to the ultrasonic diagnostic apparatus 1 and 1A according to the first and second embodiments. Next, description will be given of cases in which the configurations which provide the above effects are applied to a diagnostic imaging apparatus other than an ultrasonic diagnostic apparatus or to an image processing apparatus (workstation).

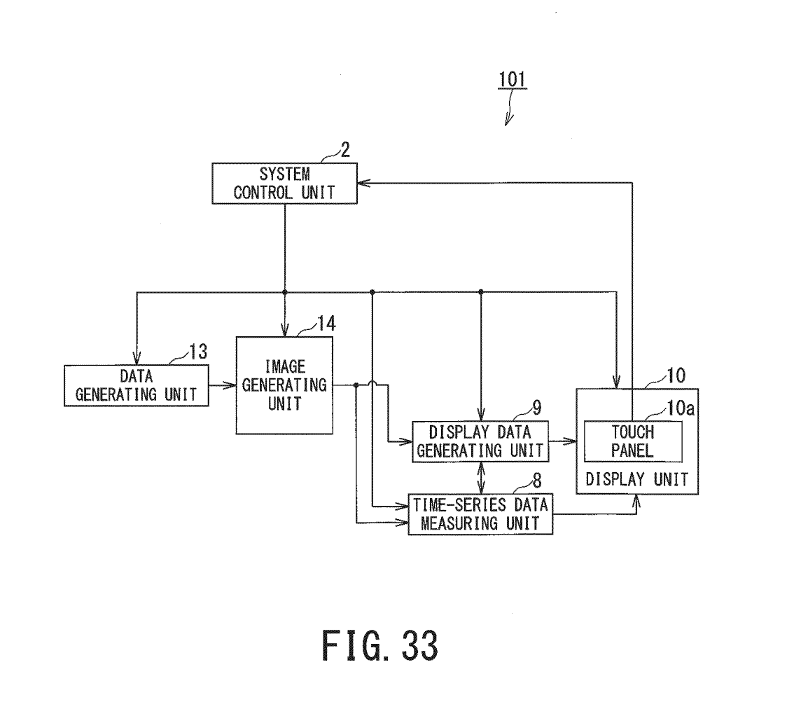

FIG. 33 is a block diagram showing an overall configuration of a diagnostic imaging apparatus according to the present embodiment.

FIG. 33 shows the diagnostic imaging apparatus 101 according to the present embodiment. Examples of the diagnostic imaging apparatus 101 include an X-ray apparatus, an X-ray CT (computed tomography) apparatus, an MRI (magnetic resonance imaging) apparatus, and a nuclear medicine apparatus. The diagnostic imaging apparatus 101 includes a system control unit 2, a time-series data measuring unit 8, a display data generating unit 9, a display unit 10, a data generating unit 13, and an image generating unit 14. Also, the diagnostic imaging apparatus 101 may have an input unit 12 (shown in FIG. 29). In the diagnostic imaging apparatus 101 shown in FIG. 33, the same components as those of the ultrasonic diagnostic apparatus 1 or 1A shown in FIG. 1 or FIG. 29 are denoted by the same reference numerals as the corresponding components in FIG. 1 or FIG. 29, and description thereof will be omitted.

The data generating unit 13, which includes an apparatus adapted to generate data, generates data used before generating an image. If the diagnostic imaging apparatus 101 is an X-ray apparatus, the data generating unit 13 includes an X-ray tube, an X-ray detector (FPD), and an A/D (analog to digital) converter. If the diagnostic imaging apparatus 101 is an X-ray CT apparatus, the data generating unit 13 includes an X-ray tube, an X-ray detector, and a DAS (data acquisition system). If the diagnostic imaging apparatus 101 is an MRI apparatus, the data generating unit 13 includes a static magnet, a gradient coil, and an RF (radio frequency) coil. If the diagnostic imaging apparatus 101 is a nuclear medicine apparatus, the data generating unit 13 includes a detector adapted to catch gamma rays emitted from radioisotopes (RIs).

Based on data generated by the data generating unit 13, the image generating unit 14 generates images such as X-rays images, CT images, MRI images, or PET (positron emission tomography) images.

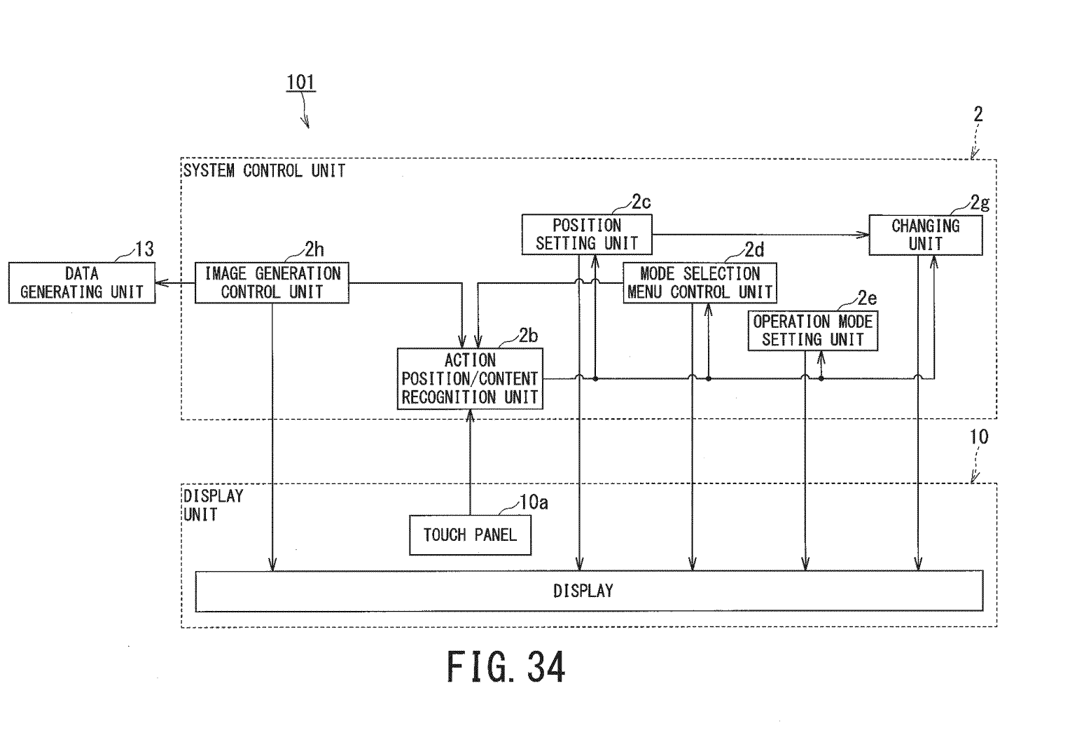

FIG. 34 is a block diagram showing functions of the diagnostic imaging apparatus 101 according to the present embodiment.

As the system control unit 2 shown in FIG. 33 executes a program, the diagnostic imaging apparatus 101 functions as an acting position/content recognition unit 2b (2b′), a position setting unit 2c (2c′), a mode selection menu control unit 2d (2d′), an operation mode setting unit 2e (2e′), a changing unit 2g (2g′), and an image generation control unit 2h. In the diagnostic imaging apparatus 101 shown in FIG. 34, the same components as those of the ultrasonic diagnostic apparatus 1 or 1A shown in FIG. 3 or FIG. 30 are denoted by the same reference numerals as the corresponding components in FIG. 3 or FIG. 30, and description thereof will be omitted.

The image generation control unit 2h has a function to make the image generating unit 14 (shown in FIG. 33) generate images, by controlling the data generating unit 13. Also, the image generation control unit 2h has a function to display the images generated by the image generating unit 14, on the display of the display unit 10 via the display data generating unit 9 (shown in FIG. 33).

For example, operation of the acting position/content recognition unit 2b, position setting unit 2c, and mode selection menu control unit 2d of the diagnostic imaging apparatus 101 is similar to the operation described with reference to FIGS. 26A and 26B as well as to the operation described with reference to FIGS. 27A and 27B. Their difference lies only in whether a background is an ultrasonic image such as shown in FIGS. 26A and 26B, FIGS. 27A and 27B or another medical image.

Since a setting for a position an area of interest in a displayed image and a display the mode selection menu on the display are executed, simultaneously, in response to a single action while the image is displayed on the display of the display unit 11, the diagnostic imaging apparatus 101 according to the present embodiment can reduce operator actions, shorten the time required for the operator to get used to actions, and thereby allow the operator to select a mode in a simple and easy manner. Also, the diagnostic imaging apparatus 101 according to the present embodiment allows examination times to be reduced.

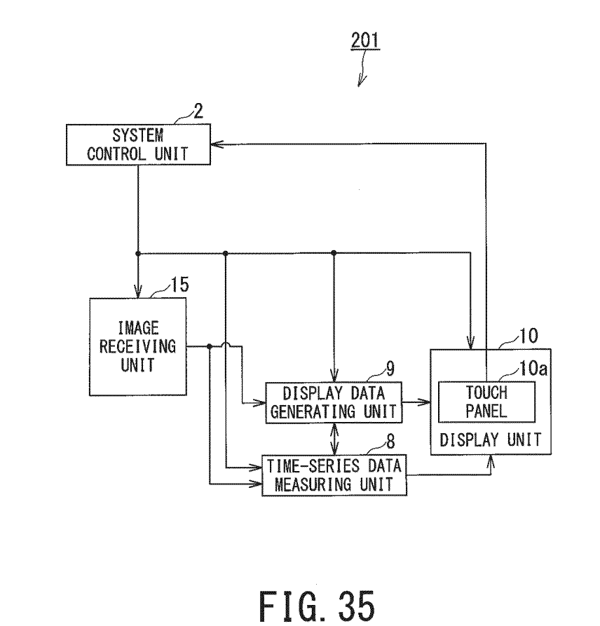

FIG. 35 is a block diagram showing an overall configuration of an image processing apparatus according to the present embodiment.

FIG. 35 shows the image processing apparatus 201 according to the present embodiment. The image processing apparatus 201 includes a system control unit 2, a time-series data measuring unit 8, a display data generating unit 9, a display unit 10, and an image receiving unit 15. The image processing apparatus 201 may include an input unit 12 (shown in FIG. 29). In the image processing apparatus 201 shown in FIG. 35, the same components as those of the ultrasonic diagnostic apparatus 1 or 1A shown in FIG. 1 or FIG. 29 are denoted by the same reference numerals as the corresponding components in FIG. 1 or FIG. 29, and description thereof will be omitted.

The image receiving unit 15 receives images from apparatus (not shown) which hold images (ultrasonic images, X-rays images, CT images, MRI images, and nuclear medicine images) of conventional ultrasonic diagnostic apparatus or image servers. For example, the image receiving unit 15 receives images via a network such as a LAN (local area network) provided as part of hospital infrastructure. The images received by the image receiving unit 15 are outputted to the display data generating unit 9 and a memory (not shown) under the control of the system control unit 2.

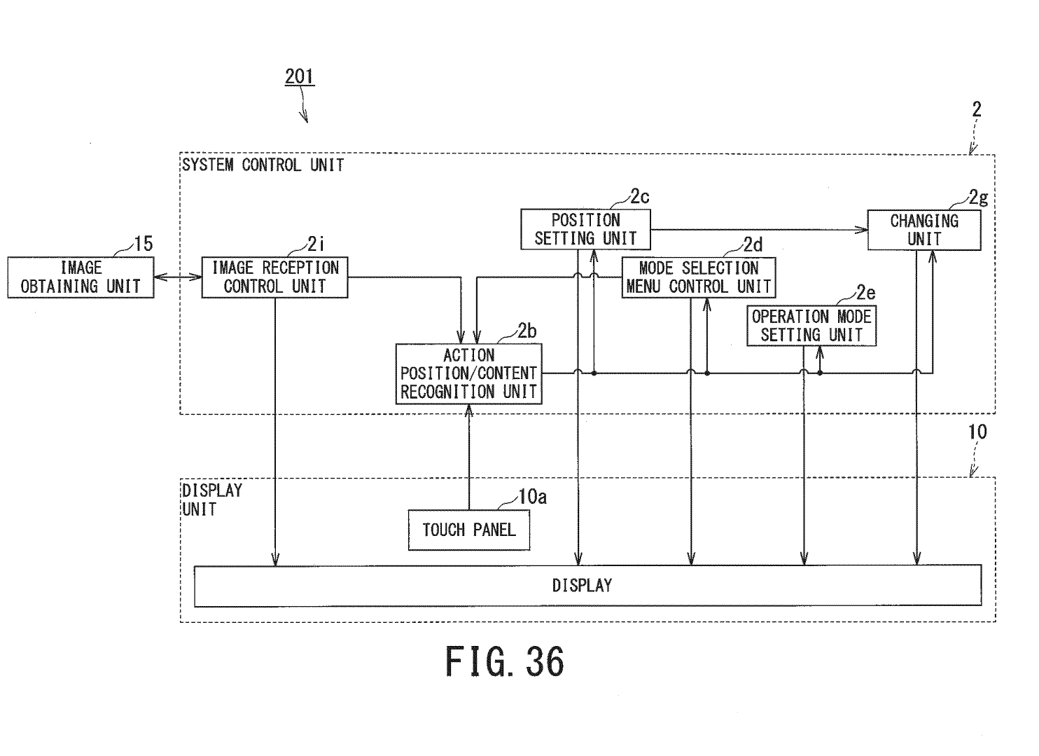

FIG. 36 is a block diagram showing functions of the image processing apparatus 201 according to the present embodiment.

As the system control unit 2 shown in FIG. 35 executes a program, the image processing apparatus 201 functions as an acting position/content recognition unit 2b (2b′), a position setting unit 2c (2c′), a mode selection menu control unit 2d (2d′), an operation mode setting unit 2e (2e′), a changing unit 2g (2g′), and an image reception control unit 2i. In the image processing apparatus 201 shown in FIG. 36, the same components as those of the ultrasonic diagnostic apparatus 1 or 1A shown in FIG. 3 or FIG. 30 are denoted by the same reference numerals as the corresponding components in FIG. 3 or FIG. 30, and description thereof will be omitted.

The image reception control unit 2i has a function to control and make the image receiving unit 15 receive images. Also, the image reception control unit 2i has a function to display images received by the image receiving unit 15, on the display of the display unit 10 via the display data generating unit 9 (shown in FIG. 35).

For example, operation of the acting position/content recognition unit 2b, position setting unit 2c, and mode selection menu control unit 2d of the image processing apparatus 201 is similar to the operation described with reference to FIGS. 11A-11D and FIG. 12. The background may be an ultrasonic image such as shown in FIGS. 11A-11D and FIG. 12. With the image processing apparatus 201, the end point and start point of a velocity trace in a Doppler spectrum image are configurable as well.

Also, for example, the operation of the acting position/content recognition unit 2b, position setting unit 2c, and mode selection menu control unit 2d of the image processing apparatus 201 is similar to the operation described with reference to FIGS. 26A and 26B as well as to the operation described with reference to FIGS. 27A and 27B. Their difference lies only in whether a background is an ultrasonic image such as shown in FIGS. 26A and 26B, FIGS. 27A and 27B or another medical image.

Since a setting for a position of an area of interest in a displayed image and a displaying of the mode selection menu on the display are executed, simultaneously, in response to a single action while the image is displayed on the display of the display unit 11, the image processing apparatus 201 according to the present embodiment can reduce operator actions, shorten the time required for the operator to get used to actions, and thereby allow the operator to select a mode in a simple and easy manner. Also, the image processing apparatus 201 according to the present embodiment allows examination times to be reduced.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

The accompanying claims and their equivalents are intended to cover such forms or modifications as would fall within the scope and spirit of the inventions.

What is claimed is:

1. An ultrasonic diagnostic apparatus equipped with a display unit configured to display an ultrasonic image, comprising:
a controller configured to execute a setting for a position of an area of interest in the displayed ultrasonic image and a displaying of a mode selection menu on the display unit, simultaneously, in response to a single action while the ultrasonic image is displayed on the display unit.

2. The ultrasonic diagnostic apparatus according to claim 1, wherein
the controller executes the setting for the position of the area of interest and the displaying of the mode selection menu, simultaneously,
according to a predetermined action on a touch panel provided on a display surface of the display unit.

3. The ultrasonic diagnostic apparatus according to claim 2, wherein
the controller displays the mode selection menu centering on a position of a press action or a release action on the touch panel.

4. The ultrasonic diagnostic apparatus according to claim 1, wherein
the controller executes the setting for the position of the area of interest in the ultrasonic image and the displaying of the mode selection menu, simultaneously, in response to the single action while the ultrasonic image is displayed on the display unit, the mode selection menu selecting one of a color Doppler mode, a pulse Doppler mode, a caliper mode, and a trace mode.

5. The ultrasonic diagnostic apparatus according to claim 4, wherein
the controller executes the setting for the position of the area of interest in a B-mode image as the ultrasonic image and the displaying of the mode selection menu, simultaneously, in response to the single action while the B-mode image is displayed on the display unit, the mode selection menu selecting one of the color Doppler mode, the pulse Doppler mode, the caliper mode, and the trace mode.

6. The ultrasonic diagnostic apparatus according to claim 4, wherein
the controller displays, when the color Doppler mode is selected on the mode selection menu, an ROI (region of interest) as the area of interest corresponding to the selected color Doppler mode.

7. The ultrasonic diagnostic apparatus according to claim 4, wherein
the controller displays, when the pulse Doppler mode is selected on the mode selection menu, a range gate as the area of interest corresponding to the selected pulse Doppler mode.

8. The ultrasonic diagnostic apparatus according to claim 4, wherein
the controller displays, when the caliper mode is selected on the mode selection menu, a measuring caliper as the area of interest corresponding to the selected caliper mode.

9. The ultrasonic diagnostic apparatus according to claim 4, wherein
the controller displays, when the trace mode is selected on the mode selection menu, a start point of tracing as the area of interest corresponding to the selected trace mode.

10. The ultrasonic diagnostic apparatus according to claim 4, wherein
the controller executes the setting for the position of the area of interest in a Doppler spectrum image as the ultrasonic image and the displaying of the mode selection menu,
simultaneously, in response to the single action while the Doppler spectrum image is displayed on the display unit, the mode selection menu selecting at least a velocity trace.

11. The ultrasonic diagnostic apparatus according to claim 1, wherein
the controller displays, when a mode is selected on the mode selection menu, the area of interest corresponding to the selected mode on the ultrasonic image.

12. The ultrasonic diagnostic apparatus according to claim 11, wherein
the controller changes a display position of the area of interest in response to a change action of the area of interest.

13. The ultrasonic diagnostic apparatus according to claim 1, wherein
the controller executes the setting for position of the area of interest and the displaying of the mode selection menu, simultaneously, in response to a predetermined action carried out by an operator via an input unit.

14. A diagnostic imaging apparatus equipped with a display unit configured to display a medical image, comprising:
a controller configured to execute a setting for a position of an area of interest in the displayed medical image and a displaying of a mode selection menu on the display unit, simultaneously, in response to a single action while the medical image is displayed on the display unit.

15. An image processing apparatus equipped with a display unit configured to display a medical image, comprising:
a controller configured to execute a setting for a position of an area of interest in the displayed medical image and a displaying of a mode selection menu on the display unit, simultaneously, in response to a single action while the medical image is displayed on the display unit.

16. A program stored in a non-transitory computer-readable recording medium executed by a computer, comprising:
displaying a medical image on a display unit; and
executing a setting for a position of an area of interest in the displayed medical image and a displaying of a mode selection menu on the display unit, simultaneously, in response to a single action while the medical image is displayed on the display unit.
